(19) United States
(12) Patent Application Publication
(10) Pub. No.: US 2008/0310510 A1
(43) Pub. Date: Dec. 18, 2008

(54) Image Coding, Recording and Reading Apparatus

(75) Inventors: Norimichi Hiwasa, Tokyo (JP); Hideki Inomata, Tokyo (JP); Hiroharu Sakate, Tokyo (JP); Ayako Nemoto, Tokyo (JP)

Correspondence Address: BIRCH STEWART KOLASCH & BIRCH, PO BOX 747, FALLS CHURCH, VA, 22040-0747, US

(73) Assignee: MITSUBISHI ELECTRIC CORPORATION, Tokyo (JP)

(21) Appl. No.: 11/883,292

(22) PCT Filed: Jan. 12, 2006
(86) PCT No.: PCT/JP2006/300302

§ 371 Date: Jul. 30, 2007

(30) Foreign Application Priority Data
Mar. 22, 2005 (JP) 2005-082114

(51) Int. Cl. H04N 7/26

(52) U.S. Cl. 375/240.16; 375/E07.125

(57) ABSTRACT

An image coding, recording and reading apparatus generates a local decoded image which is used for motion compensation prediction at the same time when coding an original image to be coded so as to generate an original image coded stream, acquires a difference image which is a difference between the local decoded image and the original image to be coded, codes the difference image so as to generate a difference image coded stream, records the original image coded stream and the difference image stream generated thereby into a storage memory, and adds an original image and a difference image which are obtained by decoding both the above-mentioned coded streams read out of the storage memory, respectively, so as to generate an addition image.

### FIELD OF THE INVENTION

The present invention relates to an image coding, recording and reading apparatus which codes image data, such as image data about a broadcast program, records the coded image data thereinto, and outputs the recorded coded stream at a coding rate depending upon (or suiting) its use.

### BACKGROUND OF THE INVENTION

Generally, a method of temporarily recording contents data containing an image and a sound into a predetermined memory after creating them, and reading and using them when a request to read and use them is made. When recording contents data into the memory, they are coded to compress the amount of information of the contents data with the input/output rate of the memory being reduced to a low one. As uses of the coded contents data which are thus recorded and stored, there are a record of them into another recording media, such as a DVD, broadcasting, and a stream distribution via a transmission line. Therefore, there is a demand to suit one contents data to two or more uses. Thus, an image coding, recording and reading apparatus which is so constructed as to support two or more uses needs to provide a transmission rate depending upon (or suiting) each use for coded data read from a memory.

As a prior art image coding, recording and reading apparatus which meets such a demand, patent reference 1 discloses an apparatus which codes program information (contents data) at different coding rates, in different coding modes, or in different graphics formats by using two or more coding units, records each coded data into a storage memory, and, when receiving, for example, a request to output a data stream, such as a stream distribution request, selects and outputs coded data mostly suitable to the transmission rate of the channel at that time. Furthermore, when the coding rate of the coded data is lower than the transmission rate of the channel, this prior art apparatus inserts dummy data into the coded data by using an output-rate adjusting unit additionally included therein, to select an output having a rate which is increased to the same as the transmission rate of the channel. Another example of this apparatus is so constructed as to decode coded data read out of the storage memory using a decoding unit, and select an output which is coded again at a rate lower than an original coding rate by using a coding unit additionally included therein.

In general, an image coding, recording and reading apparatus which handles an image of a broadcast program can code and record one program (contents) at a time. Some image coding, recording and reading apparatuses which handle an image of a broadcast program can code and record two programs simultaneously. Such an apparatus which records two programs simultaneously codes data about two different programs simultaneously by using two coding units so as to generate coded streams, and records both of them into an identical storage memory. When then recording them into an external disk for record, the apparatus transfers either of the coded streams recorded into the storage memory just as it is, or decodes the coded streams recorded into the storage memory and carries out a process of coding them again at a low rate and then recording them. Therefore, when recording only one program, the apparatus uses only one coding unit with the remaining coding unit being set to a non-use state.

[Patent reference 1] JP,9-74559,A (FIGS. 1 and 2)

A problem with prior art image coding, recording and reading apparatus constructed as mentioned above is that they do not have any function of improving the image quality of a coded stream according to its use when coding the coded stream again. A problem with image coding, recording and reading apparatus which can record two or more programs simultaneously is that when recording only one program, other coding units are not used and the utilization factor of the coding units is small.

The present invention is made in order to solve the above-mentioned problems, and it is therefore an object of the present invention to provide an image coding, recording and reading apparatus which codes an image of one program and stores it in the form of a coded stream, and, when reading and using the coded stream at the time of a playback of the coded stream, provides a coding rate depending upon (or suiting) its use to the data to be outputted, thereby improving or maintaining the image quality of the coded stream.

### DISCLOSURE OF THE INVENTION

In accordance with the present invention, there is provided an image coding, recording and reading apparatus which codes an original image to be coded according to a predetermined coding method, records the coded original image into a storage memory, and outputs a coded stream read out of the above-mentioned storage memory in a form depending upon (or suiting) use of the coded stream, the apparatus including: an image coding means for generating a local decoded image which is used for motion compensation prediction from the original image to be coded at the same time when coding the original image to be coded so as to generate an original image coded stream, for acquiring a difference image which is a difference between the above-mentioned local decoded image and the above-mentioned original image to be coded, for coding the acquired difference image so as to generate a difference image coded stream, and for recording the original image coded stream and the difference image stream generated thereby into the storage memory; and an image decoding means for decoding each of the original image coded stream and the difference image coded stream read out of the storage memory to generate a decoded original image and a decoded difference image, and for adding both the decoded images so as to generate an addition image.

Therefore, at the time of coding the inputted original image, the apparatus generates and codes the difference image of the original image, records the coded streams of both of the images generated thereby, and, at the time of a playback, augments the amount of information of the decoded original image with the decoded difference image acquired by decoding the difference image. As a result, the image quality of the output is maintained at a high level. When the present invention is applied to an image coding, recording and reading apparatus which is so constructed as to record two or more programs simultaneously, coding units and decoding units which are placed in a non-use state when the apparatus records only one program can be used effectively.

### BRIEF DESCRIPTION OF THE FIGURES

FIG. 1 is a block diagram showing the structure of an image coding, recording and reading apparatus in accordance with embodiment 1 of the present invention;

FIG. 2 is a block diagram showing an example of the structure of a first coding unit in accordance with embodiment 1 of the present invention;

FIG. 3 is an explanatory diagram showing an operation of generating a difference image which is performed by a difference unit in accordance with embodiment 1 of the present invention;

FIG. 4 is the explanatory diagram showing an example of reduction in a bit width at the time of coding the difference image which is carried out by a coding unit in accordance with embodiment 1 of the present invention;

FIG. 5 is an explanatory diagram showing a judgment operation for reduction in the amount of coding information in accordance with embodiment 1 of the present invention;

FIG. 6 is an explanatory diagram showing an example of coding of an ineffective section of the difference image in accordance with embodiment 1 of the present invention;

FIG. 7 is an explanatory diagram showing a relation between an actual amount of information and the image quality at the time of real-time VBR control;

FIG. 8 is an explanatory diagram showing an improvement in the image quality at the time of non-real-time VBR control in accordance with embodiment 1 of the present invention;

FIG. 9 is an explanatory diagram showing an example of a frame in which the difference values of the difference image in accordance with embodiment 1 of the present invention are partially set to “0”;

FIG. 10 is a block diagram showing the structure of an image coding, recording and reading apparatus in accordance with embodiment 2 of the present invention;

FIG. 11 is an explanatory diagram showing an amount of generated information of a frame in accordance with embodiment 2 of the present invention;

FIG. 12 is a block diagram showing the structure of an image coding, recording and reading apparatus in accordance with embodiment 3 of the present invention;

FIG. 13 is a block diagram showing the structure of an image coding, recording and reading apparatus in accordance with embodiment 4 of the present invention;

FIG. 14 is an explanatory diagram showing a state shift of the remaining amount of a storage memory in accordance with embodiment 4 of the present invention;

FIG. 15 is an explanatory diagram showing an example of a screen on which program information recorded into the storage memory in accordance with embodiment 4 of the present invention is displayed;

FIG. 16 is an explanatory diagram showing an example of a method of coding a difference image in accordance with embodiment 4 of the present invention;

FIG. 17 is an explanatory diagram showing an example of an amount of information which is assigned to each frame at the time of coding of the difference image in accordance with embodiment 4 of the present invention;

FIG. 18 is an explanatory diagram showing an example of a frame of the difference image in which isolated points, a person's face, and so on exist;

FIG. 19 is an explanatory diagram showing a relation between coding of an original image and the boundaries of blocks to be coded when coding the difference image;

FIG. 20 is a block diagram showing the structure of an image coding, recording and reading apparatus in accordance with embodiment 5 of the present invention;

FIG. 21 is a block diagram showing the structure of an image coding, recording and reading apparatus in accordance with embodiment 6 of the present invention;

FIG. 22 is an explanatory diagram showing coded frames and decoded frames which are processed during a one-frame time interval in accordance with embodiment 6 of the present invention;

FIG. 23 is a block diagram showing the structure of an image coding, recording and reading apparatus in accordance with embodiment 7 of the present invention; and

FIG. 24 is a block diagram showing the structure of an image coding, recording and reading apparatus in accordance with embodiment 8 of the present invention.

### PREFERRED EMBODIMENTS OF THE INVENTION

Hereafter, in order to explain this invention in greater detail, the preferred embodiments of the present invention will be described with reference to the accompanying drawings.

Although an image coding, recording and reading apparatus shown in each of the following embodiments which will be explained below is constructed of a plurality of functional units, many of these functional units can be implemented via software using a microprocessor.

### Embodiment 1

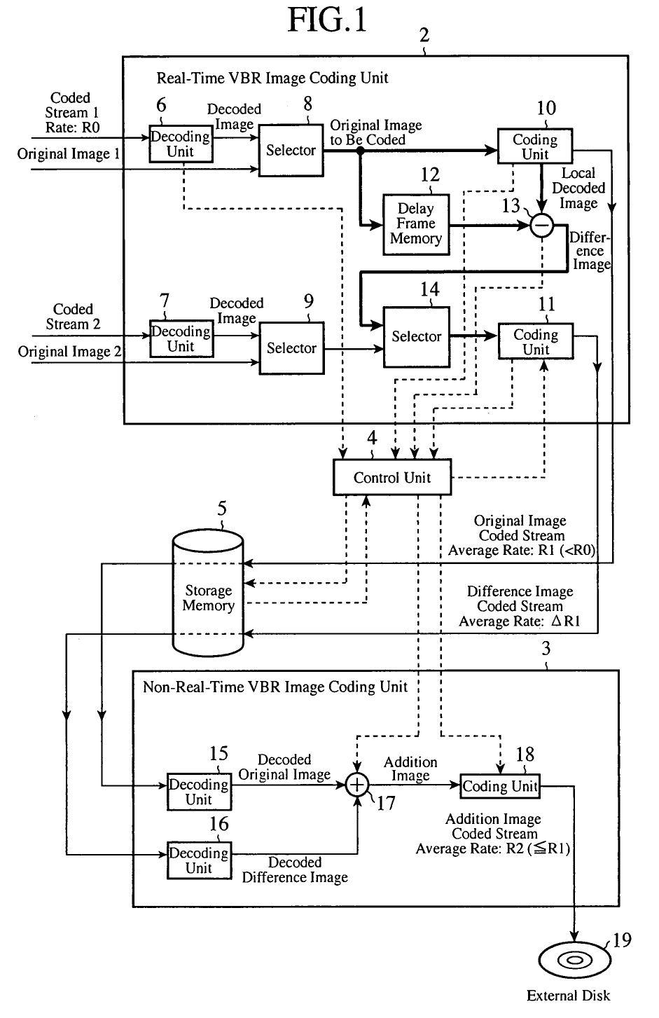

FIG. 1 is a block diagram showing the structure of an image coding, recording and reading apparatus in accordance with embodiment 1 of the present invention. The image coding, recording and reading apparatus shown in FIG. 1 has a structure of coding contents data about different images inputted simultaneously thereto so as to generate coded streams, recording them into an identical storage memory, and recording one of the coded streams which is selected from the storage memory into a record external disk. In this embodiment 1, an explanation of an application of the image coding, recording and reading apparatus will be made by focusing on a process of recording only one program into a storage memory and a process of reading a program from a storage memory.

This image coding, recording and reading apparatus is provided with a real-time VBR (Variable Bit Rate) image coding unit (i.e., an image coding means) 2, a non-real-time VBR image coding unit 3, a control unit 4, and a storage memory 5. Hereafter, assume that image content data are inputted to this image coding, recording and reading apparatus in a signal format of either original image data (referred to as an original image from here on) or a coded stream which is obtained by coding and compressing the original image. An output from this apparatus is a coded stream (referred to as an addition image coded stream from here on), and is used, as an example, for recording into a dismountable external disk 19.

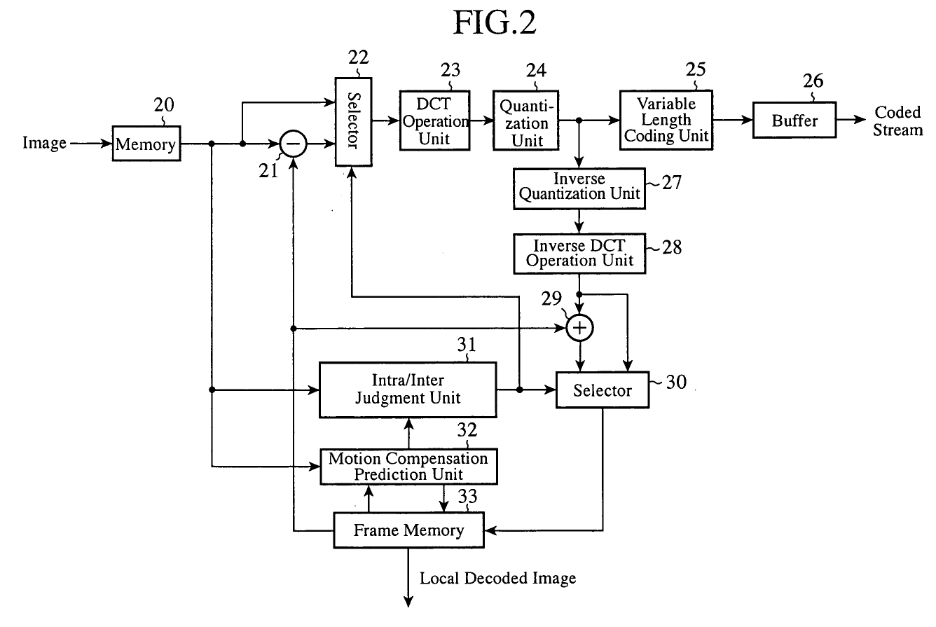

In the real-time VBR image coding unit 2, decoding units 6 and 7 are means for, when coded streams are inputted to the image coding, recording and reading apparatus, decoding them respectively. Selectors 8 and 9 are means for selecting either decoded images obtained by the decoding units 6 and 7 or the original image, respectively. A coding unit (i.e., a first coding unit) 10 is a means for coding the inputted image (i.e., either the original image 1 or the decoded image from the decoding unit 6, and is referred to as an original image to be coded from here on) so as to generate a coded stream (referred to as an original image coded stream from here on). This coding unit 10 has a function of outputting a local decoded image which is used for motion compensation prediction in a display order, as will be mentioned later with reference to FIG. 2. A delay frame memory 12 is a means for providing an amount of delay which synchronizes the local decoded image from the coding unit 10, which is given to the difference unit 13, with a time frame position to the original image to be coded. A difference unit 13 is a means for calculating a difference between the original image to be coded which is delayed and the local decoded image from the coding unit 10 so as to generate a difference image. A selector 14 is a means for selecting either the generated difference image or an original image to be coded associated with the other channel from the selector 9. A coding unit (i.e., a second coding unit) 11 is a means for usually coding the original image to be coded associated with the other channel which is different from that associated with the coding unit 10, but, in accordance with the present invention, is also a means for coding the difference image generated by the difference unit 13 so as to generate a difference image coded stream.

The control unit 4 is a means for acquiring, as supplementary information, information about an operation result from each unit of the image coding, recording and reading apparatus, and for setting up a mode for each unit, as will be mentioned below. The storage memory 5 in accordance with the present invention is a storage means for recording and reading the coded streams of the original image and the difference image, and the supplementary information which the control unit 4 has acquired from each unit.

In the non-real-time VBR image coding unit 3, each of decoding units 15 and 16 and a coding unit 18 can be so constructed as to be the same as the decoding units 6 and 7, and the coding unit 10 of the real-time VBR image coding unit 2, respectively. The decoding unit (i.e., a first decoding unit) 15 is a means for reading the original image coded stream from the storage memory 5, and then decoding this stream. The decoding unit (i.e., a second decoding unit) 16 is a means for reading the difference image coded stream from the storage memory 5, and then decoding this stream. A decoding adder unit 17 is a means for adding the decoded difference image to the decoded original image, the decoded images being respectively decoded by the decoding units 15 and 16, so as to generate an addition image. The coding unit (i.e., a third coding unit) 18 is a means for coding the addition image so as to generate an addition image coded stream, and for outputting this stream to the external disk 19.

The coding unit (i.e., the first coding unit) 10 of this embodiment 1 has a function of outputting the local decoded image which is used for motion compensation prediction, and an example of the coding unit to which an MPEG-2 coding method is applied is shown in FIG. 2.

In FIG. 2, several frames of the inputted image are held by a memory 20. A frame on which coding is to be performed is read out of the memory 20. This reading operation is carried out for each block to be coded (in the case of MPEG-2, it is called a macro block), and a motion compensation prediction unit 32 performs motion compensation prediction on the frame read on the basis of a reference image currently held by a frame memory 33. An intra/inter judgment unit 31 compares the result of the motion compensation prediction with the input block to be coded so as to judge whether to select either intra (intra frame) coding or inter (inter frame) coding. The intra/inter judgment unit selects intra coding when the picture to be coded is an I picture. A selector 22 selects either the image on which the frame difference operation is performed by a difference unit 21, or the input block to be coded itself from the memory 20 on the basis of the result of the judgment of intra/inter coding. After the output of the selector 22 is converted into DCT coefficients by a DCT (Discrete Cosine Transform) operation unit 23, they are quantized by a quantization unit 24.

The quantized result obtained by the quantization unit 24 is converted into a variable length code by a variable length coding unit 25, and an acquired coded stream is temporarily held by a buffer 26. The coded stream is outputted from the buffer 26. After an inverse quantization process is performed on the quantized result by an inverse quantization unit 27, an inverse DCT operation is performed on the inverse-quantized result by an inverse DCT operation unit 28. A selector 30 selects either the output of the inverse DCT operation unit 28 and the result of inter-frame addition carried out by a frame adder unit 29 on the basis of the judgment result of the intra/inter judgment unit 31. The output of the selector 30 is held by the frame memory 33, and is used as a reference image for motion compensation prediction on the next frame to be coded. The local decoded image held by the frame memory 33 is outputted in a display order as the local decoded image in accordance with this embodiment 1.

Referring again to FIG. 1 showing the image coding, recording and reading apparatus, the operation of the image coding, recording and reading apparatus will be explained.

Hereafter, a case in which the image coding, recording and reading apparatus retrieves and processes only one program from programs currently being broadcast, and records it into the external disk 19. As an outline operation of the image coding, recording and reading apparatus, the image coding, recording and reading apparatus performs first-time VBR coding in real time on the image of the one program, and records the VBR-coded image into the storage memory 5. Next, when recording the coded stream read out of the storage memory 5 into the external disk 19, after decoding the coded stream, the image coding, recording and reading apparatus performs second-time VBR coding on the decoded data in non-real time. At that time, when the average coding rate of the coded stream which is to be recorded into the external disk 19 is the same as that, or when the average coding rate of the coded stream which is to be recorded into the external disk 19 is smaller than that, the quality of the image of the coded stream to be recorded is improved.

When the one program inputted to the image coding, recording and reading apparatus is a program of analog broadcasting, a digital original image 1 into which the analog original is converted is inputted, whereas when the one program is a program of digital broadcasting, a coded stream 1 (coding rate: R0) is inputted. When the coded stream 1 is inputted, a decoded image is generated by the decoding unit 6. A selection of either the original image 1 or the decoded image is carried out by the selector 8. In the case of this input example, only the image (i.e., the original image to be coded) outputted from the selector 8 is coded according to a flow designated by a thick line shown in the figure. The image to be coded from the selector 8 is inputted to both the coding unit 10 and the delay frame memory 12. The original image to be coded which is inputted to the coding unit 10 is VBR-coded with an average rate R1 (<R0) so that it is transformed into an original image coded stream, and this stream is recorded into the storage memory 5. The coding unit 10 outputs the local decoded image which is used for motion compensation prediction to the difference unit 13, as explained with reference to FIG. 2.

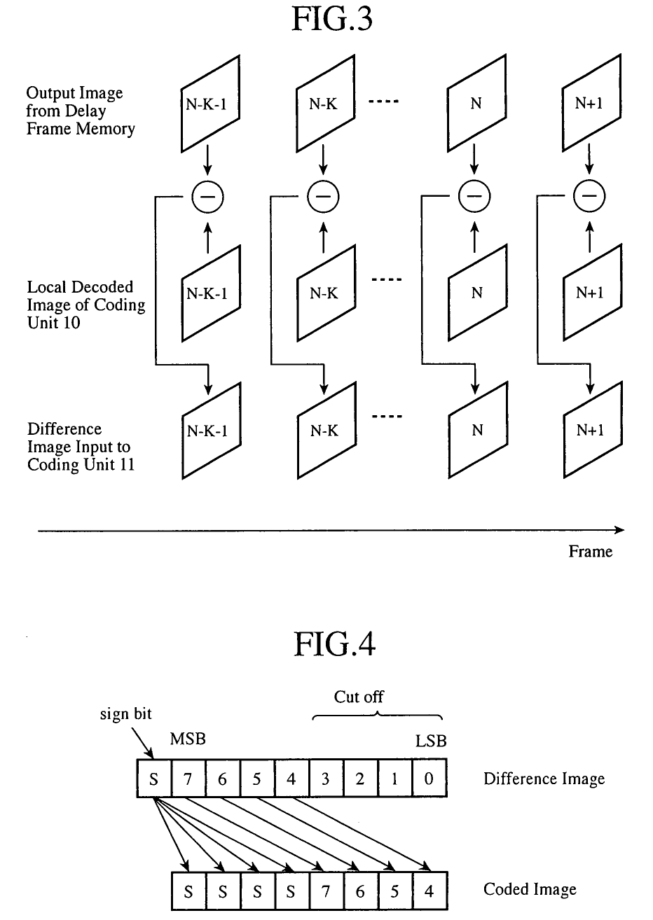

On the other hand, the phase of the image to be coded inputted to the delay frame memory 12 is adjusted so that it is in phase with the local decoded image. As shown in FIG. 3, the difference unit 13 generates a difference image which is a difference between the image to be coded and the local decoded image of the coding unit 10, which are made to be in phase with each other, and inputs the difference image to the coding unit 11 via the selector 14. The coding unit 11 codes the difference image, and records a difference image coded stream generated thereby into the storage memory 5. With the series of these coding operations, the control unit 4 acquires information on the processing result of each unit, and records it into the storage memory 5 as supplementary information, reads the supplementary information according to the use of the apparatus, and operates so as to use it for control of each unit of the image coding, recording and reading apparatus. Typically, as this supplementary information, there are parameters, such as a quantization scale average, a total amount of generated information, a motion vector amount of information, etc. per frame which are acquired when the decoding unit 6 decodes the coded stream 1 inputted thereto. Furthermore, there are parameters, such as a quantization scale average, a total amount of generated information, a motion vector amount of information, and the sum of the pixel absolute values of the difference image which is the difference between the local decoded image and the original image to be coded, etc. per frame which are acquired when the coding unit 10 codes the original image to be coded. In addition, there are parameters, such as a quantization scale average, a total amount of generated information, a motion vector amount of information, etc. per frame which are acquired when the coding unit 11 codes the difference image. Each of these parameters is used for determining beforehand a target amount of information for all the frames in a time direction when the non-real-time VBR image coding unit 3 carries out coding.

Hereafter, an example of the coding operation of the coding unit 11 will be explained.

Because the difference image coded stream generated by the coding unit 11 is also recorded into and held by the storage memory 5, the smaller amount of the difference image coded stream, the better. While the bit width (the number of effective bits) of the difference image is 9 bits, it is necessary to transform the difference image into the one having 8-bit bit width because it is specified according to the specifications of MPEG-2 or the like that the bit width of a pixel which is to be coded must be 8 bits. Therefore, when transforming the difference image into the one having a 8-bit bit width, the coding unit 11 reduces the number of effective bits, e.g., cuts down the lowermost four bits of the effective bits, as shown in FIG. 4. Thus, by reducing the number of effective bits, the dynamic range can be reduced and the code amount can also be reduced.

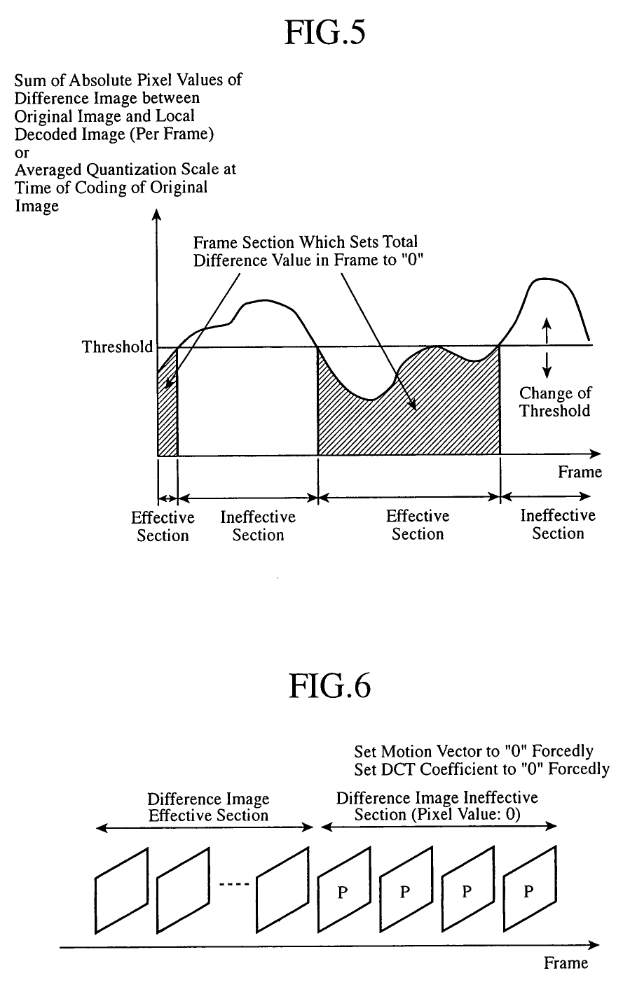

As shown in FIG. 5, as a method of reducing the amount of coded information of the difference image, a method of coding the difference image after setting up a threshold and performing a judgment on the difference image using the threshold can be provided. When either an averaged quantization scale for every frame from the coding unit 10, which is acquired by the control unit 4 or the sum of the pixel absolute values of differences among the pixels from the difference unit 13 is larger than the threshold, the coding unit 11 judges whether the difference image of each frame is effective or ineffective as the target to be coded so as to set the difference image of each frame as being effective as the target to be coded, and otherwise sets the difference image of each frame as being ineffective as the target to be coded. The coding unit 11 then carries out coding of only frames of the difference image which are judged as being effective. In this case, because the non-real-time VBR image coding unit 3 needs to perform a corresponding control operation, it is necessary to combine an identifier (i.e., a frame number) of the coded frame with the coded stream which is obtained by coding the difference image, and to record it into the storage memory 5. When the complicatedness of the control is taken into consideration, it is desirable that coding is performed on all the frames.

As a variant of the method of carrying out the above-mentioned judgment, the coding unit 11 can simply code each frame of the difference image which is judged as being effective, whereas the coding unit 11 can code each frame of the difference image which is judged as being ineffective after setting all the pixel values of the difference image to “0”. In this case, there is no necessity to give a frame identification number to each frame. Furthermore, when coding a frame in which all the pixel values are set to “0” because it is judged that the frame is ineffective, as shown in FIG. 6, the coding unit can code all frames with a forward-predicted P picture, and can also forcedly set the motion vector to “0” and forcedly set all the DCT coefficients to “0”. By doing in this way, the coding unit can reduce the amount of information for each ineffective frame greatly. In addition, the coding unit can change the amount of coded information of the difference image by changing the threshold which serves as a criterion of judgment of whether each frame effective or ineffective at any time.

Hereafter, an operation effect which is produced by recording the coded stream of the difference image into the storage memory 5 and by using it will be mentioned.

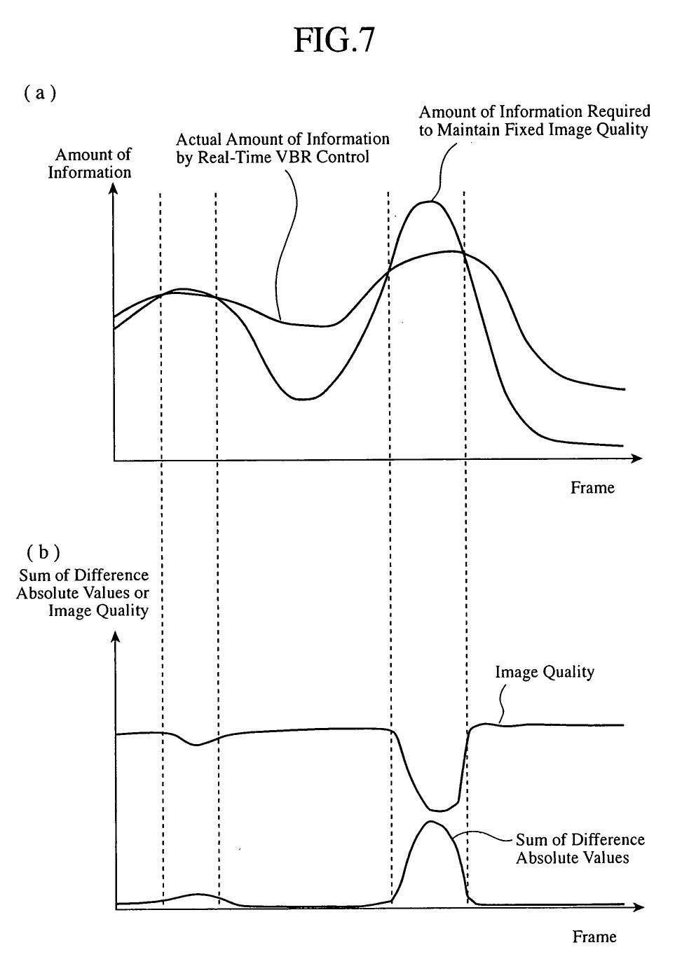

In accordance with this embodiment 1, the image coding, recording and reading apparatus performs real-time VBR coding on an image inputted thereto with a predetermined average rate to generate a coded stream, and records the coded stream in the storage memory 5. Because it is unknown that what kind of image will be inputted to the image coding, recording and reading apparatus when carrying out coding in real time, the image coding, recording and reading apparatus determines the amount of information which it will generate from the inputted image according to a difference with the average rate of the amount of information which has been created by the time the coding is performed, and the difficulty of the coding of the inputted image. Therefore, an amount of information required in order to maintain fixed image quality on an average throughout the whole image (frame) in a time direction with a predetermined average rate is not necessarily given, and it can be considered that the amount of information actually given through the real-time VBR control is typically given by a curve as shown in FIG. 7(a). At this time, it can be considered that the relative image quality is given by a curve as shown in FIG. 7(b). That is, it can be considered that while the image quality of each frame to which an amount of information equal to or lager than the amount of information required to maintain the fixed image quality is assigned is maintained to more than certain image quality, the image quality of each frame to which no amount of information equal to or lager than the amount of information required to maintain the certain image quality is assigned degrades extremely. It can also be assumed that the sum of the pixel absolute values of differences acquired by the difference unit 13 at this time is shown by a curve as shown in FIG. 7 (b).

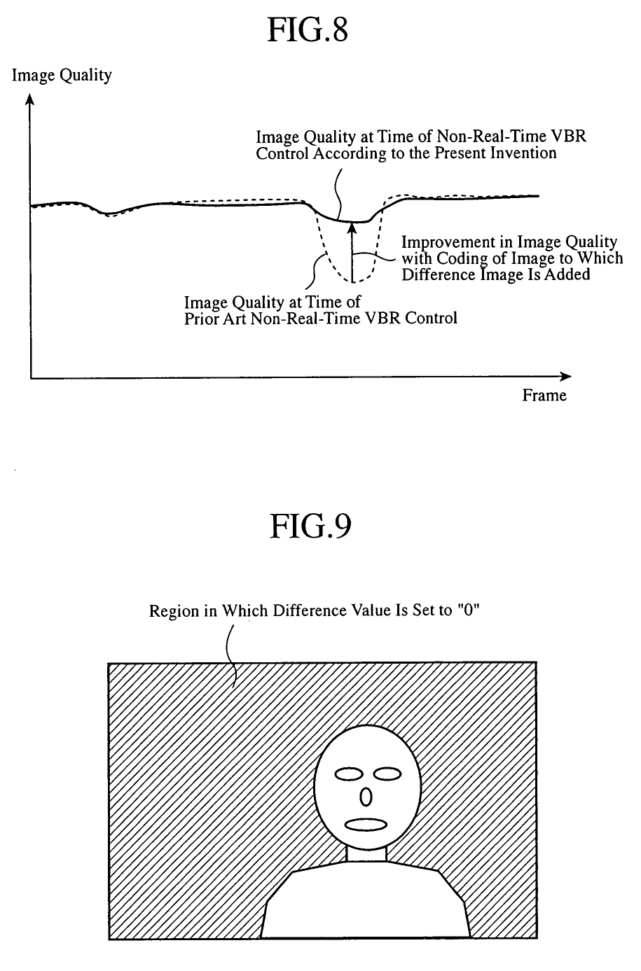

In contrast, when carrying out coding in non-real time, because the apparatus can also acquire information on an image which will be inputted thereto at a later time from the supplementary information which is beforehand stored in the storage memory 5, the apparatus should be able to assign the amount of information for acquiring certain image quality on an average throughout the whole image (frame) in a time direction to each frame. According to this embodiment 1, it is assumed that the coding unit 10 of the real-time VBR image coding unit 2 performs first-time coding on the original image to be coded, and records the coded original image, and the non-real-time VBR image coding unit 3 performs second-time coding on the image which is obtained by decoding the recorded original image coded stream at a coding rate equal to or lower than that used at the first-time coding. However, when it is assumed that both the codings are carried out at the same average rate, even if any amount of information is assigned, in the second-time coding, to a frame whose image quality has degraded extremely at the time of the first-time coding, it is impossible to improve the image quality up to more than that at the time of the first-time coding. It can be understood that, as shown in FIG. 8, if the coding unit is so constructed as to carry out the second-time coding after easing the degradation in the image quality of a frame whose image quality has degraded extremely to some extent by adding the decoded difference image from the decoding unit 16 to the decoded image obtained by the decoding unit 15, the image quality of the frame can be improved to more than the image quality of the frame obtained at the time of the first-time coding. It can also be understood that by assigning the amount of information more than needed to each frame at the time of the first-time coding, the apparatus provides an image having average image quality if, in the second-time coding, assigning only a needed amount of information to each frame whose image quality has become better than the average. By carrying out the coding according to such a method, the apparatus can reduce the frequency of occurrence of images whose image quality degrades extremely, and can improve the image quality of the whole image in a time direction on an average.

Next, the operation of the non-real-time VBR image coding unit 3 which implements the above-mentioned method will be explained. Because the decoding units 15 and 16 and the coding unit 18 are of the same types as the decoding units 6 and 7 and the coding unit 10 which the real-time VBR image coding unit 2 employs, respectively, and the non-real-time VBR image coding unit 3 is made to operate at the time when the real-time VBR image coding unit 2 does not operate, the decoding units and the coding unit can be shared by the real-time VBR image coding unit and the non-real-time VBR image coding unit.

The decoding unit 15 reads the original image coded stream which is previously generated by the coding unit 10 of the real-time VBR image coding unit 2 and is recorded into the storage memory 5, and decodes the original image coded stream. Similarly, the decoding unit 16 reads the difference image coded stream which is generated by the coding unit 11 of the real-time VBR image coding unit 2 and is recorded into the storage memory 5, and decodes the difference image coded stream. Next, the frames of the decoded original image decoded by the decoding unit 15 and those of the decoded difference image decoded by the decoding unit 16 are added respectively by the decoding adder unit 17. When carrying out the addition, the decoding adder unit returns the bit positions of the difference image to their original ones.

Next, second-time VBR coding is performed on the addition image acquired by the decoding adder unit 17 by the coding unit 18. The average coding rate R2 at this time is equal to or less than the average coding rate R1 at the time of the first-time coding. Because the coded results of all the frames are recorded, as supplementary information, into the storage memory 5 at the time of the real-time VBR image coding, at the time of the non-real-time VBR coding the control unit 4 uses the supplementary information including up to the one about the whole image in the time direction so as to determine the target amount of information which is to be assigned to each frame. Therefore, the coding unit 18 codes the addition image on the basis of this target amount of information. At the time of the real-time VBR coding, the control unit 4, when the coding unit 11 codes the difference images of only frames each of which has been judged as being coded for reduction in the amount of coded information of the difference image, reads a frame identifier indicating each frame which has been coded from the storage memory 5, and controls the decoding adder unit 17 to add only the decoded difference image of the frame corresponding to the identifier. In the coding unit 18, the addition image coded stream resulting from the second-time VBR coding has an average rate R2 (<=R1), and is outputted and recorded into the external disk 19.

By carrying out the second-time VBR coding as mentioned above, the apparatus can make the coded stream which is recorded into the external disk 19 have higher image quality on average than or much the same image quality with a lower rate as the coded stream recorded into the storage memory 5 throughout the whole time.

Although some examples of the method of reducing the amount of coded information of the difference image have been explained above, another example will be explained hereafter. As shown in FIG. 9, when detecting that the pixel absolute values of differences among pixels in a frame of the difference image are smaller than a certain threshold, or when detecting difference pixel values which exist in a location outside a region which catches a viewer's eye, such as a face in frames of the difference image, the coding unit 11 can code the difference image after forcedly setting the corresponding difference pixel values to “0”. In another example, the coding unit 11 can code the difference image after changing its graphics format (e.g., the image size) so as to make the image has a size smaller than that of the image to be coded, and, when decoding the difference image coded stream read out of the storage memory 5, the decoding unit 16 can carry out the adding process by using the decoding adder unit 17 after restoring the image size of the decoded difference image to the original size.

In this embodiment, the case in which MPEG-2 is applied as an example of the coding method has been explained, but the present invention can also be applied to H.261, MPEG-1, MPEG-4, and H.264. Because the inter-frame difference and addition are performed on the pixels of the original image to be coded and those of the decoded original image, the same coding method does not necessarily need to be used for the coding unit 10 and the coding unit 11.

In FIG. 1, two or more non-real-time VBR image coding units 3 can be disposed in parallel for the storage memory 5, and the decoding of the coded streams of the original image and the difference image, the addition of the decoded images decoded, and the coding of the addition image cam be carried out with time division or for separated portions of the screen, respectively. In this case, because the apparatus can perform the decoding and the recoding at a high speed, it can reduce the processing time.

As mentioned above, in accordance with embodiment 1, in the real-time VBR image coding process, the apparatus generates a local decoded image which is used for motion compensation prediction from the image to be coded at the same time when it codes the image to be coded so as to generate an original image coded stream, acquires a difference image which is a difference between this local decoded image and the image to be coded, codes the acquired difference image so as to generate a difference image coded stream, and records both the original image coded stream and the difference image which are thus generated into the storage memory, and, in the non-real-time VBR image coding process, after decoding each of both the coded streams of the image to be coded and the difference image read out of the storage memory, the apparatus adds both of the decoded images, and codes an acquired addition image so as to generate an image coded stream. Therefore, the present embodiment offers an advantage of being able to make the image coded stream generated through the recoding have high image quality. Furthermore, when the present embodiment is applied to an image coding, recording and reading apparatus which is so constructed as to record simultaneously two or more programs as shown in FIG. 1, coding units and decoding units which are placed in a non-use state when the apparatus records only one program can be used effectively.

### Embodiment 2

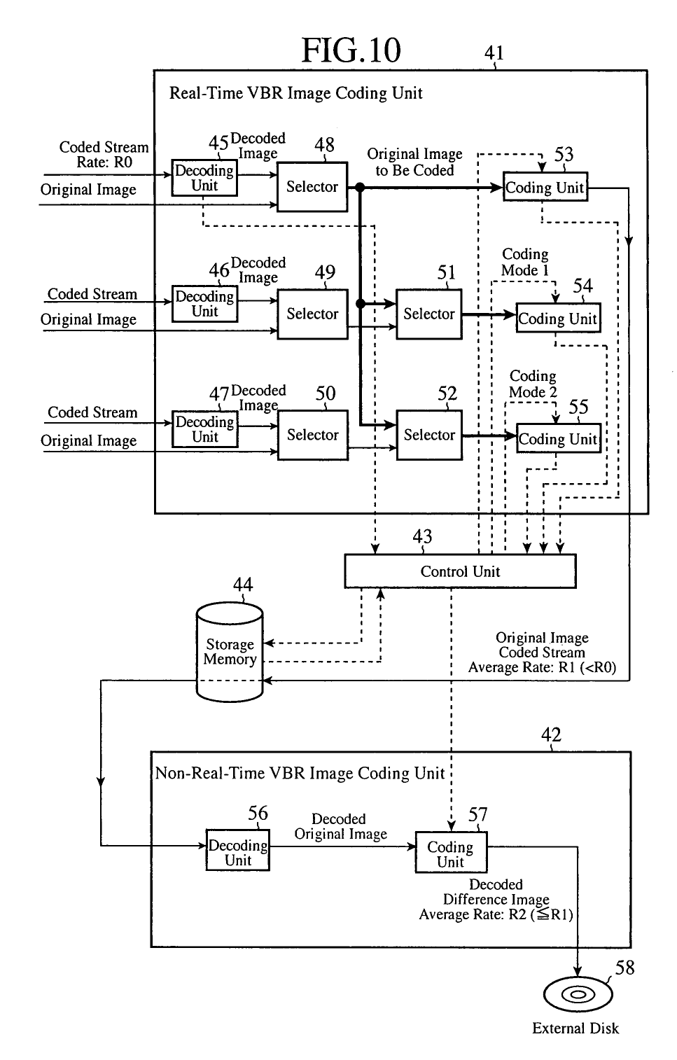

FIG. 10 is a block diagram showing the structure of an image coding, recording and reading apparatus in accordance with embodiment 2 of the present invention.

The image coding, recording and reading apparatus is provided with a real-time VBR image coding unit 41, a non-real-time VBR image coding unit 42, a control unit 43, and a storage memory 44.

In the structure of the real-time VBR image coding unit 41, decoding units 45, 46, and 47 are means for, when inputs to the image coding, recording and reading apparatus are coded streams, decoding them, respectively. Selectors 48, 49, and 50 are means for selecting either decoded images decoded by the decoding units 45, 46, and 47 or the original image, respectively. Selectors 51 and 52 are means for selecting either the output of the selector 48, or the outputs of the selectors 49 and 50, respectively. Coding units 53, 54, and 55 are means for coding the original images to be coded which are inputted thereto simultaneously in different coding modes, respectively.

On the other hand, in the structure of the non-real-time VBR image coding unit 42, because a decoding unit 56 and a coding unit 57 are of the same types as the decoding unit 45 and the coding unit 53 of the real-time VBR image coding unit 41, respectively, and the non-real-time VBR image coding unit 42 is made to operate at the time when the real-time VBR image coding unit 41 does not operate, the decoding units and the coding unit can be shared by the real-time VBR image coding unit and the non-real-time VBR image coding unit. The control unit 43 is a means for setting up a mode to each unit of the image coding, recording and reading apparatus, and for acquiring information associated with the operation of each unit. The storage memory 44 is a storage means for recording the coded stream and the information which the control unit 43 has acquired from each unit, and for reading them. An external disk 58 is a dismountable recording medium for recording the coded stream generated by the coding unit 57.

Next, the operation of the apparatus in accordance with this embodiment of the present invention will be explained.

Hereafter, an explanation will be made as to a method of, in a case of recording only one program currently being broadcast into the external disk 58, preventing the coded stream which is recorded into the external disk 58 at a coding rate lower than that of the coded stream which is recorded into the internal storage memory 44 from degrading in image quality as much as possible.

Assuming that only an image of one program is coded and recorded, the selector 48 selects, as the original image to be coded, either a decoded image which is obtained by decoding the inputted coded stream by using the decoding unit 45 or the digital original image. As shown by a thick line of FIG. 10, at the same time when the original image to be coded from the selector 48 is inputted directly to the coding unit 53, it is also inputted to the other coding units 54 and 55 via the selectors 51 and 52. The coding unit 53 performs image coding on the original image to be coded at a variable rate so that it can have a set-up average rate R1 (<R0), and records the generated original image coded stream into the storage memory 44. The coding units 54 and 55 code the original image to be coded in their respective coding modes which differ from each other and also differ from that of the coding unit 53, but do not record the generated original image coded streams into the storage memory 44.

In the coding modes, the coding units 54 and 55 carry out the coding with a quantization scale being fixed to an identical value for all the frames, for example, while the coding unit 54 sets the interval (i.e., the M value) of P pictures to “3” and carries out the coding with B pictures of bidirectional prediction (this mode is referred to as coding mode 1), whereas the coding unit 55 sets the interval of P pictures to “1”, i.e., carries out the coding without B pictures (this mode is referred to as coding mode 2).

The setting of the coding modes of the coding units 54 and 55 is carried out by the control unit 43 at the time of the coding. The control unit 43 records, as coding information, information about the set-up coding modes, the total amount of generated information, the amount of motion vector information, etc. of the whole frame at the time of the coding which are acquired from the coding units 53, 54, and 55 into the storage memory 44.

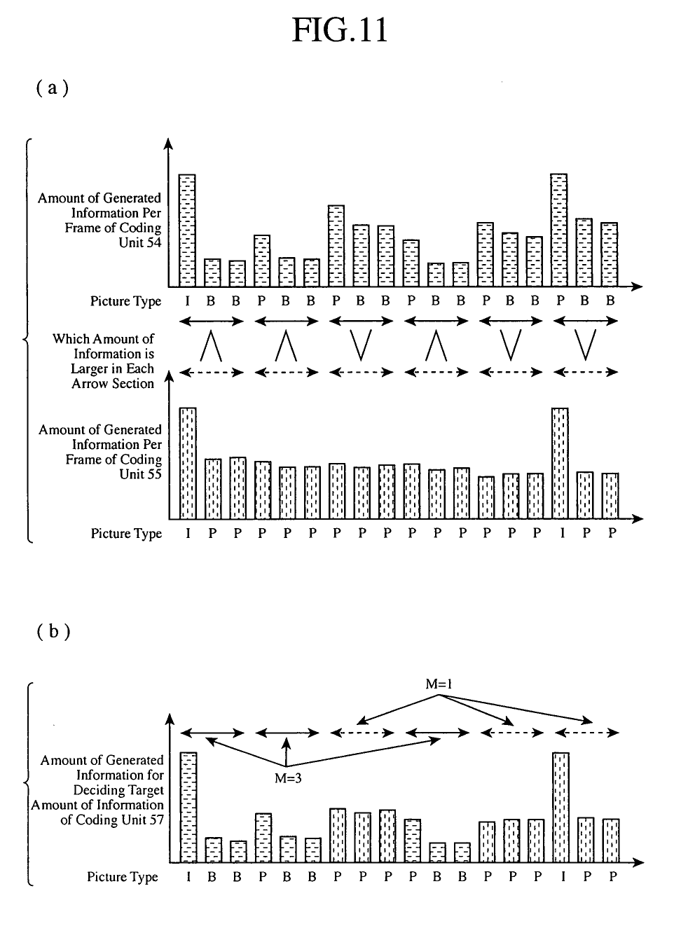

Hereafter, a relation between the amount of generated information per frame at the time when the coding units 54 and 55 carry out the coding without recording the generated original image coded streams into the storage memory 44, and the target amount of information which is used for the operation of the coding unit 57 which will be mentioned later will be explained with reference to FIG. 11.

An upper portion of FIG. 11(a) shows the amount of generated information per frame by the coding unit 54 which sets the M value to “3”, and a lower portion of FIG. 11(a) shows the amount of generated information per frame by the coding unit 55 which sets the M value to “1.” In this example, the apparatus calculates the sums of the amounts of generated information by both the coding units for every three frames, and selects a smaller one from among the corresponding sums, and determines the M value of the coding unit 57, as shown in FIG. 11(b). When carrying out the coding on the basis of the amount of generated information per frame which is associated with the M value which is calculated in this way, the coding unit 57 calculates the target amount of information which is assigned to each frame of the whole image.

In the operation of the non-real-time VBR image coding unit 42, the decoding unit 56 reads the original image coded stream which is previously generated by the coding unit 53 and which is recorded into the storage memory 44 from the storage memory 44, and decodes the stream so as to acquire a decoded original image. The decoded original image from the decoding unit 56 is coded by the coding unit 57 at an average coding rate R2 (<=R1) lower than that at the time of the coding by the coding unit 53. At this time, the control unit 43 compares the amount of generated information in the coding mode 1 by the coding unit 54 with the amount of generated information in the coding mode 2 by the coding unit 55 per a predetermined number of frames (in this example, per three frames), the M value of the coding unit having a smaller amount of generated information per the predetermined number of frames is applied to the coding of the coding unit 57. The control unit 43 uses the total amount of generated information and the amount of motion vector information included in the coding information recorded into the storage memory 44, i.e., the information on frames in all time directions. In this case, the control unit 43 determines the target amount of information which is assigned to all the frames on the basis of the total amount of generated information in the coding mode at the time when switching to the M value of the above-mentioned coding unit having a smaller amount of generated information every predetermined number of frames in advance for the whole image which is to be coded by the coding unit 57. The coding unit 57 codes each frame to which this target amount of information is assigned, and outputs the generated coded stream to the external disk 58 so as to record it.

As mentioned above, according to this embodiment 2, the real-time VBR image code unit codes one original image to be coded in different coding modes by using two or more coding units, records only the original image coded stream generated by one of them into the storage memory, and records coding information which consists of information about the coding modes used simultaneously, the total amount of generated information and the amount of motion vector information per frame, which are acquired through the coding operations of the two or more coding units, into the above-mentioned storage memory, and the non-real-time VBR image coding unit decodes the original image coded stream recorded into the storage memory by using the decoding unit thereof, and carries out recoding of the generated decoded original image in a coding mode selected from the coding information by using the coding unit of the same type as the above-mentioned one of the coding units, and by assigning the target amount of information beforehand decided on the basis of coding information to all frames in a time direction, so as to output the generated original image coded stream. Therefore, even when carrying out the recoding at an average coding rate lower than that at the time of the first-time coding, the apparatus can reduce the degradation in the image quality to a minimum by determining an optimal mode (in this example, an optimal M value). In this example, the coding units 53, 54, and 55 need to use an identical coding method.

### Embodiment 3

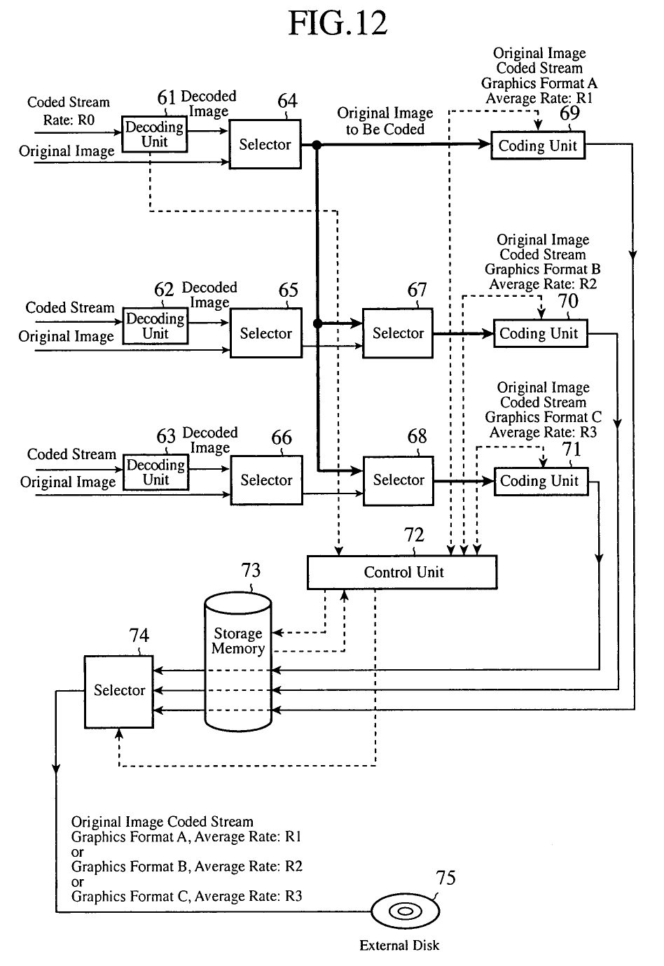

FIG. 12 is a block diagram showing the structure of an image coding, recording and reading apparatus in accordance with embodiment 3 of the present invention.

The image coding, recording and reading apparatus is provided with decoding units 61, 62, and 63, selectors 64 to 68 and 74, coding units 69, 70, and 71, a control unit 72, and a storage memory 73. The decoding units 61, 62, and 63 are means for, when inputs to the image coding, recording and reading apparatus are coded streams, decoding them. The selectors 64, 65, and 66 are means for selecting either decoded images generated by the decoding units 61, 62, and 63 or the original image, respectively. The selector 67 is a means for selecting either the output of the selector 64 or the output of the selector 65. The selector 68 is a means for selecting either the output of the selector 64 or the output of the selector 66. The coding units 69, 70, and 71 are means for coding one inputted original image to be coded according to predetermined coding methods so as to generate original image coded streams, respectively. The control unit 72 is a means for setting up a mode to each unit of the image coding, recording and reading apparatus, and for acquiring information from each unit. The storage memory 73 is a storage means for recording the original image coded streams and the information which the control unit 72 has acquired from each unit, and for reading them. The selector 74 is a means for selecting a coded stream to be read out from the two or more original image coded streams recorded into the storage memory 73.

Next, the operation of the apparatus in accordance with this embodiment of the present invention will be explained.

Assuming a case in which the apparatus codes an image of one program, either a decoded image which the decoding unit 61 generates by decoding the inputted coded stream or the digital original image is selected by the selector 64. As shown by a thick line of FIG. 12, the output of the selector 64 (i.e., the original image to be coded) is inputted to the coding unit 69, while it is also inputted to the coding units 70 and 71 via the selectors 67 and 68. The coding units 69, 70, and 71 code the one original image to be coded in their respective modes set up by the control unit 72, and record original image coded streams generated thereby into the storage memory 73. The coding at this time is real-time VBR image coding. The modes to which the coding unit are set are, for example, a mode with a graphics format (e.g., an image size) A and an average rate R1, to which the coding unit 69 is set, a mode with a graphics format B and an average rate R2, to which the coding unit 70 is set, and a mode with a graphics format C and an average rate R3, to which the coding unit 71 is set.

Next, when recording a coded stream into the external disk 75, according to the remaining amount of the disk 75, a setting input by the user, or the like, the selector 74 selects an optimal coded stream or a coded stream which is requested from among the three kinds of coded streams, and records the selected coded stream.

At the time when carrying out the above-mentioned coding, the apparatus can provide a delay of several frames for each frame which is to be coded among the coding units 69, 70, and 71. For example, when coding a certain frame, the coding unit 70 codes the frame at the expiration of several frames after the coding unit 69 codes the frame, and, at the expiration of several frames the coding unit 71 codes the frame. In this case, the coding unit 70 uses the coded result from the coding unit 69, and the coding unit 71 uses the coded results from the coding units 69 and 70. As a result, even when, for example, the average rates R1, R2, and R3 decrease in order of R1, R2, and R3, because the coding unit 71 which carries out the coding at the lowest rate R3 can use the coded results of the coding units 69 and 70, the assignment of the amount of information to each frame, the selection of the modes, etc. can be optimized, and extreme image quality degradation can be prevented even at a low rate.

Furthermore, when the image inputted to the image coding, recording and reading apparatus is a coded stream, by using decoded data acquired by the decoding unit 61, the apparatus can optimize the amount of information assigned to each frame which is to be coded by each of the coding units 69, 70, and 71 within the limits of the real-time VBR coding.

As mentioned above, the apparatus according to this embodiment 3 performs at least a pair of codings on an image of one program (i.e., an original image to be coded) in different graphics formats and at different coding rates so as to generate original image coded streams, records the generated original image coded streams into the storage memory, selects an original image coded stream having a graphics format and a coding rate depending upon (or suiting) its use from among the two or more original image coded streams recorded into the storage memory, and outputs the selected original image coded stream. Therefore, the apparatus can select an original image coded stream whose image quality is maintained or a high-quality original image coded stream, and use it. When recording a coded stream into the external disk 75, the apparatus can process it at a higher speed than at the time of recoding it in non-real time.

### Embodiment 4

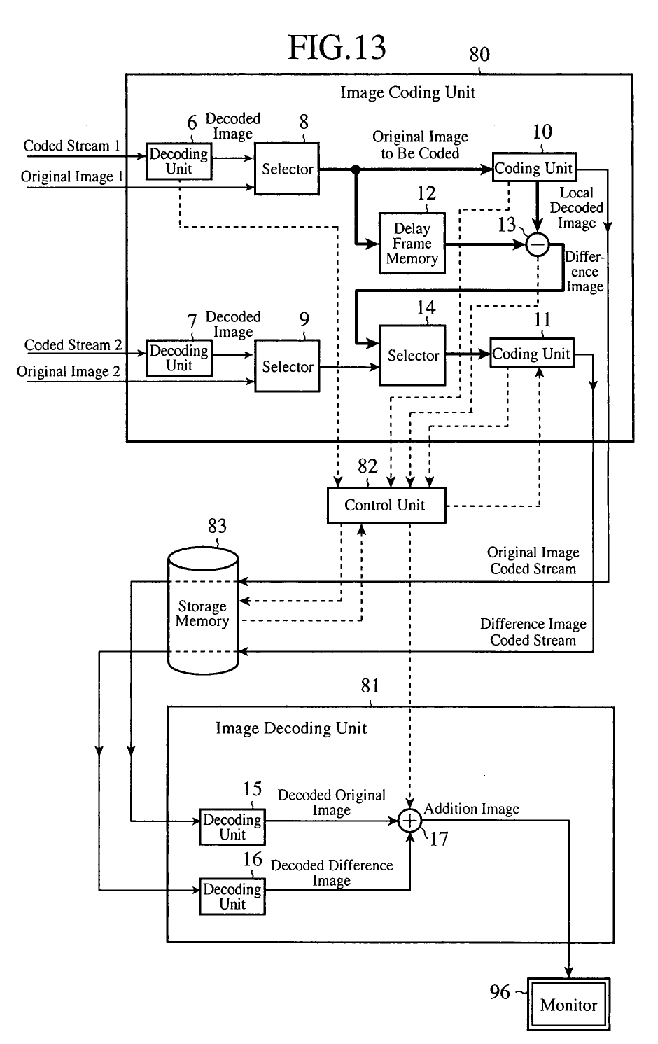

FIG. 13 is a block diagram showing the structure of an image coding, recording and reading apparatus in accordance with embodiment 4 of the present invention. In the figure, the same functional units as shown in FIG. 1 of above-mentioned embodiment 1 are designated by the same reference numerals as shown in the figure.

This image coding, recording and reading apparatus is provided with an image coding unit (an image coding means) 80, an image decoding unit (an image decoding means) 81, a control unit 82, and a storage memory 83. The image coding unit 80 has the same structure as the real-time VBR image coding unit 2 shown in FIG. 1 of embodiment 1. The storage memory 83 is a storage means of the same type as the storage memory 5 shown in FIG. 1 of embodiment 1, and has a feature in its store management of data, as will be mentioned later. The image decoding unit 81 has a structure excluding the coding unit 18 from the real-time VBR image coding unit 2 shown in FIG. 1 of embodiment 1, and provides an addition image acquired by the decoding adder unit 17 to a monitor 96 so as to acquire a playback image.

Therefore, the operations and the features which are described in embodiment 1 can be provided by the same structure of this embodiment 4. In contrast, it can be considered that features which will be described in this embodiment 4 can be applied to embodiment 1.

Next, the operation of the apparatus in accordance with this embodiment of the present invention will be explained briefly.

The image coding unit 80 typically operates in the same way as the real-time VBR image coding unit 2 in accordance with embodiment 1. That is, the coding unit (i.e., a first coding unit) 10 codes an original image to be coded so as to generate an original image coded stream. The difference unit 13 acquires a difference image which is a difference between the local decoded image generated by the coding unit 10 and the original image to be coded, and the coding unit (i.e., a second coding unit) 11 codes this difference image so as to generate a difference image coded stream. Both the coded streams of the original image and the difference image are stored in the storage memory 83. On the other hand, the image decoding unit 81 typically operates in the same way as the decoding units and the decoding adder unit 17 in the non-real-time VBR image coding unit 3 in accordance with embodiment 1. That is, the decoding unit (i.e. a first decoding unit) 15 decodes the original image coded stream read out of the storage memory 83 so as to generate a decoded original image. The decoding unit (i.e., a second decoding unit) 16 decodes the read difference image coded stream so as to generate a decoded difference image. The decoded original image and the decoded difference image which are generated are added by the decoding adder unit 17, and an addition image is outputted and displayed on the monitor 96.

Because this decoded difference image is obtained by coding a coding distortion of the result of coding the original image to be coded by using the coding unit 10 by using the coding unit 11 and then decoding the coded coding distortion by using the decoding unit 16, if the decoded difference image is added to the decoded original image, the addition image becomes close to the original image to be coded which is yet to be coded. That is, the apparatus makes it possible to make a higher-quality playback as compared with a case in which it plays back the decoded original image without adding the decoded difference image to the decoded original image.

The apparatus in accordance with this embodiment 4, in addition to performing the above-mentioned operation, has a feature in the handling of the difference image coded stream, as will be mentioned below.

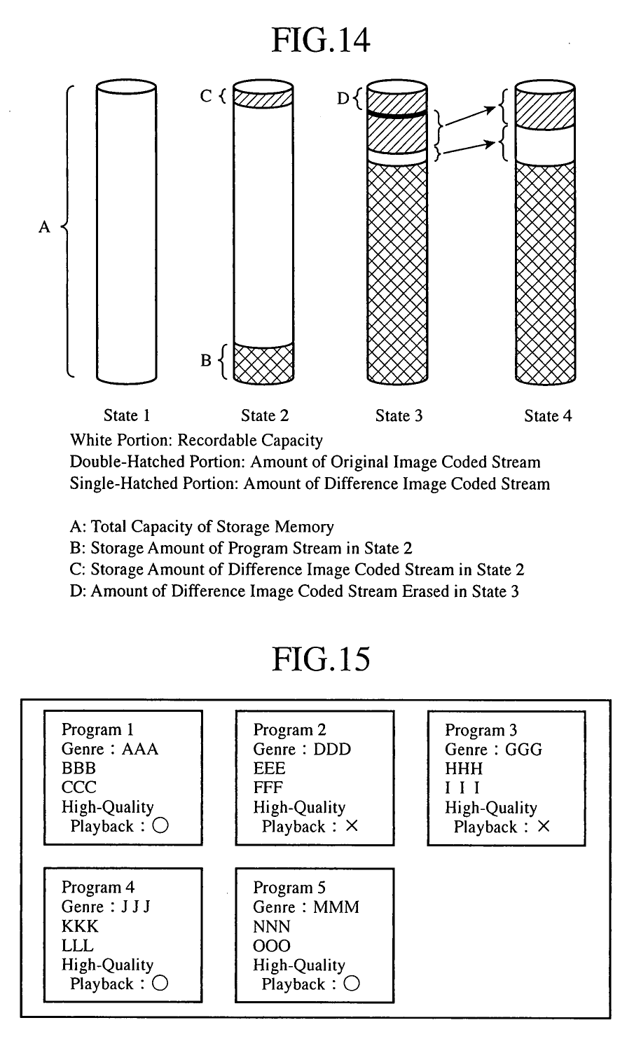

A difference image coded stream stored in the storage memory 83 is properly erased according to the remaining amount which can be recorded into the storage memory 83, as follows. A state shift of the remaining amount of the storage memory 83 is shown in FIG. 14. In the figure, state 1 shows a state in where no program is recorded into the storage memory 83, and A shows the total capacity of the storage memory. State 2 shows a state in which several programs are recorded into the storage memory. At this time, B shows the storage amount of original image coded streams, and C shows the storage amount of difference image coded streams. However, the remaining amount of a recordable region which is to be notified to the user is an amount obtained by subtracting only the storage amount of original image coded streams from the total capacity. That is, in the case of state 2, it is an amount obtained by subtracting only B from A. The next state 3 shows a state in which many programs are recorded into the storage memory and the remaining amount decreases considerably. In this state, an amount shown by D is erased from the difference image coded streams. As a result, as shown in state 4, the amount of the difference image coded streams (i.e., a hatched cylindrical portion) decreases, and the recordable amount (i.e., a white cylindrical portion) increases. When the remaining amount which can be recorded into the storage memory 83 is shown by state 4, the apparatus stores only an original image coded stream for a program which is newly recorded into the storage memory, and no difference image coded stream is generated by the second coding unit. After that, a difference image coded stream is erased properly according to the recordable amount. Finally, only the total amount A of original image coded streams are recorded into the storage memory.

The order of erasing difference image coded streams is determined on the basis of the amount of the difference image coded streams, a time which has elapsed from the date of recording each program, a record time mode at the time when coding the original image to be coded of each program, an average quantization scale value at the time when coding the original image to be coded and the difference image of each program, a time which has elapsed from the time of playing back each program for the last time, the number of times that each program has been played back, the genre of each program, an improvement rate of the S/N ratio when using the difference image of each program, and so on. For example, if the apparatus uses a method of erasing difference image coded streams in order of decreasing amount when erasing a difference image coded stream having a certain amount, a smaller number of streams will be erased. When the apparatus uses a method of erasing difference image coded streams in order of decreasing image quality of the record time mode at the time when coding the original image to be coded, the apparatus erases them starting from a difference image coded stream having a smaller degradation in its image quality because of no addition of the decoded difference image. When the apparatus uses a method of erasing difference image coded streams according to the number of times that each program has been played back, a time which has elapsed from the time of playing back each program for the last time, or the like, the apparatus can recognize the frequency with which each program is viewed and listened to, and therefore only has to erase them starting from the difference image coded stream of a program with a lower viewing-and-listening frequency. As an alternative, the order of erasing difference image coded streams can be determined by the user.

As previously explained, because the difference image coded stream is an auxiliary coded stream which is to be used strictly for a high-quality playback, it is treated so that it is erased properly when the remaining amount of the storage memory 83 is reduced. This means that there is no serious problem in using an amount which is obtained by subtracting only the amount of the original image coded stream from the total capacity as the remaining amount of the recordable region which is to be notified to the user. Because the original image coded stream remains even if the difference image coded stream is erased, a normal-image-quality playback can be carried out perfectly. That is, in a case in which the difference image coded stream exists in the storage memory 83, when decoding and playing back the original image coded stream, the apparatus carries out a high-quality playback by decoding the difference image coded stream simultaneously and adding the decoded difference image to the decoded original image. In contrast, in a case in which the original image coded stream is stored in the storage memory 83, but the corresponding difference image coded stream is not stored in the storage memory 83, the apparatus decodes only the original image coded stream by using the decoding unit 15, and outputs the decoded original image coded stream, instead of the addition image, and plays back it. Because this is a normal-image-quality playback in the recording mode which the user has specified by himself or herself, the user does not suffer any drawbacks because of no difference image stream. In order to carry out the operation explained above, the apparatus manages the original image coded stream and the difference image coded stream together per program.

The apparatus needs to manage the original image coded stream and the difference image coded stream together for every program also from the following reason. For example, when editing or erasing the original image coded stream stored in the storage memory, the apparatus must edit or erase similarly the difference image coded stream corresponding to the original image coded stream in cooperation with the above-mentioned editing or erasing. At this time, if the apparatus cannot edit the difference image stream for a reason such as a coding mode, it erases the difference image coded stream.

Furthermore, as shown in FIG. 15, the apparatus can display information about the playback image quality on the screen which is used for notifying the user of program information about any program which is recorded into the storage memory. That is, when the difference image coded stream about a recorded program is stored, the apparatus shows that it is possible to provide a high-image-quality playback output (a circle mark “o”), whereas when there is no difference image coded stream, the apparatus shows that it is possible to provide only a playback output of normal image quality (a cross mark “x”).

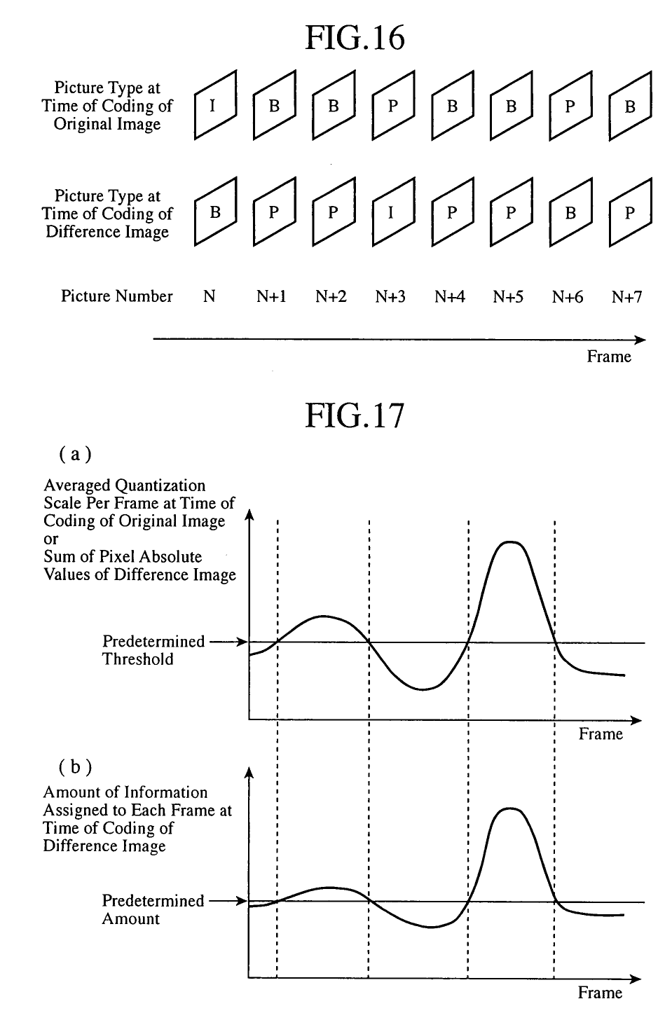

When generating a difference image coded stream by using the coding unit 11, it is important for the apparatus to carry out coding so that a smaller coding distortion occurs at any part of the original image to be coded where the coding degradation is noticeable. FIG. 16 shows a method of coding the original image to be coded by changing the coding type of a picture. For example, in the case of MPEG-2, different kinds of coding distortions and different kinds of visual noises occur among I pictures on which inner frame coding is performed, P pictures on which unidirectional inter-frame prediction is performed, and B pictures on which bidirectional inter-frame prediction is performed. Therefore, if the apparatus codes each frame of the original image to be coded and each frame of the difference image by means of a coding method of the same coding type, similar noises may occur in each frame of the original image to be coded each frame of the difference image, and the noises which occur in each frame of the original image to be coded may not be reduced. In order to prevent this disadvantage, the apparatus only has to code each frame of the original image to be coded and each frame of the difference image by means of coding methods of different coding types. At the time of the coding of the difference image, the apparatus can use a quantization matrix different from that at the time of the coding of the original image to be coded, in addition to the use of coding methods of different coding types, so that the coding of the difference image is optimized.

FIG. 17 shows an example of the amount of information which is assigned to each frame at the time of coding the difference image. FIG. 17(a) shows a change in either the average of the quantization scales of all frames at the time when the coding unit 10 codes the original image to be coded, or the sum of the pixel absolute values of the difference image which is the difference between the original image to be coded and the local decoded image. The apparatus then determines an amount of change information which corresponds to a range of the change in the quantization scale average or the sum of the pixel absolute values of the difference image with respect to a predetermined threshold. As shown in FIG. 17(b), the apparatus sets the amount of change information as a value which can be increased or decreased with respect to the predetermined value, and defines it as the amount of information which is assigned to each frame when coding the difference image by using the coding unit 11. In the coding based on MPEG-2, the larger quantization scale value, the worse image quality. Because the difference image is the difference between the original image to be coded and the local decoded image, the sum of the absolute values of the pixels of the difference image is nearly equal to the S/N ratio. That is, the fact that the sum of the absolute values of the pixels of the difference image is large equivalently means that the S/N ratio is low, and means that the image quality is bad. Therefore, because it can be assumed that a frame of the original image to be coded having a large quantization scale average or difference absolute value sum has bad image quality, the apparatus assigns a large amount of information to such a frame when coding the difference image. As a result, the image quality of the addition image which is acquired by adding the decoded difference image to the decoded original image by the image decoding unit 81, that is, the image quality of the playback image is improved greatly.

For example, an image of a program of a certain genre, such as sport or concert, may include a rapid change in motion and a rapid change in the lightness of scenes due to lighting as compared with an image of, for example, a drama program. Because such an image has a low correlation between frames, its coding efficiency is bad. In order to solve this problem, what is necessary is just to reduce the difference in coding degradation among genres. To this end, the apparatus determines the amount of information which is assigned to each frame of the difference image according to the genre of the program, and makes the coding unit 11 code the difference image with this amount of information. As a result, the difference in the image quality which is produced by the difference in the genre of the addition image which is acquired by adding the decoded difference image to the decoded original image by the image decoding unit 81, that is, the difference in the genre of the playback image.

If the average of the quantization scales of all frames is large at the time of coding of the difference image, the distortion of the difference image itself becomes large. Therefore, if the image decoding unit 81 adds a decoded difference image corresponding to such a difference image to the decoded original image, a noise which originally does not occur may occur. In performing the addition process of adding the decoded difference image to the decoded original image, the decoding adder unit 17 does not perform the process of adding the decoded difference image to the decoded original image on any frame having a larger average frame quantization scale value than either a certain decided threshold or an average frame quantization scale value at the time of coding the original image. As a result, the occurrence of the above-mentioned noise component can be prevented.

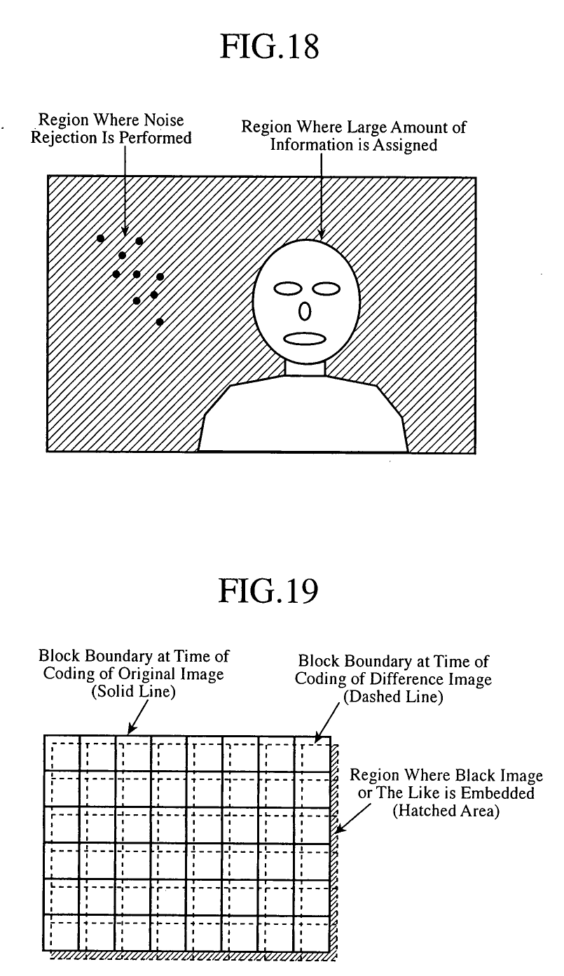

When the coding unit 10 codes the original image to be coded, a pixel which is called an isolated point with very little correlation with surrounding pixels may appear in the difference image. Although it can be assumed that this isolated point exists in the original image to be coded from the first, or it is a noise component which occurs because of the coding of the original image, this isolated point occurs at a relatively-flat portion in many cases. When such a isolated point or noise is coded just as it is, the coding efficiency decreases. There is a region which easily catches a viewer's eye, such as a person's face, in the difference image. An example of a frame of the difference image in which isolated points, a person's face, and so on exist is shown in FIG. 18. The second coding unit codes the difference image after removing signal components which are not effective visually, such as isolated points and noises, from the difference image by filtering this difference image. The second coding unit also carries out the coding of the difference image by assigning a large amount of information to the region which catches a viewer's eye. Because it is difficult to detect a person's face or the like from the difference image, as information about the presence or absence of a person's face or the like and its position on the screen, information which is obtained at the time of coding the original image to be coded can be transferred from another coding unit, and can be used.

A relation between the boundaries of blocks to be coded at the time when the image coding unit 80 codes the original image to be coded and the boundaries of blocks to be coded at the time when the image coding unit 80 codes the difference image is shown in FIG. 19. As shown in FIG. 19, the apparatus codes the difference image by shifting the boundaries of the blocks to be coded of the original image to be coded horizontally by several pixels and perpendicularly by several lines, that is, so that the boundaries of the blocks to be coded do not overlap one another. When coding the difference image by dividing each frame of the difference image into blocks, a noise which is characterized by the appearance of a block and which is called a block distortion may occur because of the coding. When coding the difference image, the apparatus can cancel out the distortion which occurs in the block boundaries because of the coding of the original image by shifting the block boundaries. In FIG. 19, the apparatus codes the difference image so that the number of horizontal pixels and the number of vertical lines of the original image are the same as those of the difference image. The apparatus can alternatively include the whole of the original image inside the difference image by increasing the number of horizontal pixels and the number of vertical lines of the difference image. In this case and in the case of FIG. 19, pixel values in a portion of the difference image outside the region of the original image are set to fixed values, such as black or gray values.

In the case of coding based on MPEG-2 or the like, 8-bit pixel values are a target for the coding, each pixel of the difference image which is the difference between the original image and the local decoded image has a 9-bit value. A method of shifting a 9-bit pixel value to make each pixel have a 8 or less bit value in order to reduce the amount of information of the difference image coded stream is explained with reference to FIG. 4 of embodiment 1. However, because each pixel of the difference image has a difference value between the original image and the local decoded image, it can be assumed that most of all the pixels in the difference image are expressed as an 8-bit value. Therefore, the apparatus performs a limit process on each pixel value instead of performing such a bit shift process, as shown by the following equations (1) and (2):

S=Pmax when S>Pmax (1)

S=Pmin when S<Pmin (2)

where S is a difference pixel value, Pmax is a maximum expressed as an 8-bit value or a maximum defined by the coding standards, and Pmin is a minimum expressed as an 8-bit value or a minimum defined by the coding standards.

Before carrying out the limit process, the apparatus can calculate the number of pixels which satisfy the equation (1) or (2) within each frame, and, when the number of pixels is larger than a predetermined threshold, perform the bit shift process on the pixels of each frame, whereas when the number of pixels is equal to or smaller than the predetermined threshold, the apparatus can perform the limit process on the pixels of each frame. At this time, when each frame is subjected to the bit shift process or the limit process, and when each frame is further subjected to the bit shift process, the apparatus needs to either hold the shifted amount, as well as the frame number of each frame, by using the storage memory 83, or carry out multiplexing of them to user data per frame of the difference image. At the time of decoding and addition, the image decoding unit 81 only has to carry out the addition after carrying out a bit shift operation toward an opposite direction on the basis of this held or multiplexed information.

When the image decoding unit 81 adds the decoded original image which it has acquired by decoding the original image coded stream, and the decoded difference image which it has acquired by decoding the difference image coded stream, the image decoding unit 81 must add corresponding frames of the images. To this end, by using a method of making the time codes of the GOP headers of the coded streams coincide with each other, and using a temporal reference multiplexed into the picture header of each frame, the apparatus achieves synchronization between the corresponding frames of the decoded original image and the decoded difference image so as to add them. As an alternative, by using a method of multiplexing a synchronizing signal into the user data, or a method of multiplexing synchronization information into VOBU (Video Object Unit) defined by the DVD recorder standards, the apparatus can achieve synchronization between the corresponding frames of the decoded original image and the decoded difference image so as to add them.

As also explained in above-mentioned embodiment 1, in accordance with this embodiment 4, the case in which MPEG-2 is applied as an example of the coding method has been explained, but the present invention can also be applied to H.261, MPEG-1, MPEG-4, and H.264. Because the inter-frame difference and addition are performed on the pixels of the original image to be coded and those of the decoded original image, the same coding method does not necessarily need to be used by the coding unit 10 and the coding unit 11.

A method of managing and erasing the difference image coded stream can be implemented by applying the method of managing or erasing the coded stream of the original image which present DVD recorders and so on employ.

As mentioned above, in the apparatus according to this embodiment 4, the image coding unit generates a local decoded image which is used for motion compensation prediction from an original image to be coded at the same time when decoding the original image to be coded so as to generate an original image coded stream, acquires a difference image which is a difference between the local decoded image and the original image to be coded, codes the acquired difference image so as to generate a difference image coded stream, and records the original image coded stream and the difference image stream which are generated into the storage memory, and the image decoding unit decodes each of the original image coded stream and the difference image coded stream read out of the storage memory so as to generate a decoded original image and a decoded difference image, and, after that, adds the decoded difference image to the decoded original image so as to generate an addition image. Therefore, the apparatus can maintain the quality of the output image at a high level. In addition, by using an empty region of the storage memory which is not used originally, the apparatus makes it possible to carry out a playback of an image having higher quality than normal quality, the storage memory can be effectively used.

When the difference image coded stream which is used for high-quality playback can be properly erased according to the remaining amount of a recordable region of the storage memory, the original image coded stream cannot be necessarily recorded by only a shorter time than originally expected because of the storage of the difference image coded stream. In other words, the user can use all of the first record time of the storage memory for the original image coded stream. Because the original image coded stream in a recording mode which the user sets up by himself or herself remains in the storage memory even if the difference image coded stream is erased, the apparatus can carry out a playback with original image quality which the user sets up, and therefore there causes no drawbacks to the user.

Furthermore, in a case in which the difference image coded stream exists in the storage memory, as shown in above-mentioned embodiment 1, when recoding the difference image coded stream in order to record it into an external disk of small capacity, the apparatus codes the addition image which is obtained by adding the decoded difference image to the decoded original image, thereby being able to reduce the degradation of the image quality at a low rate to a minimum.

### Embodiment 5

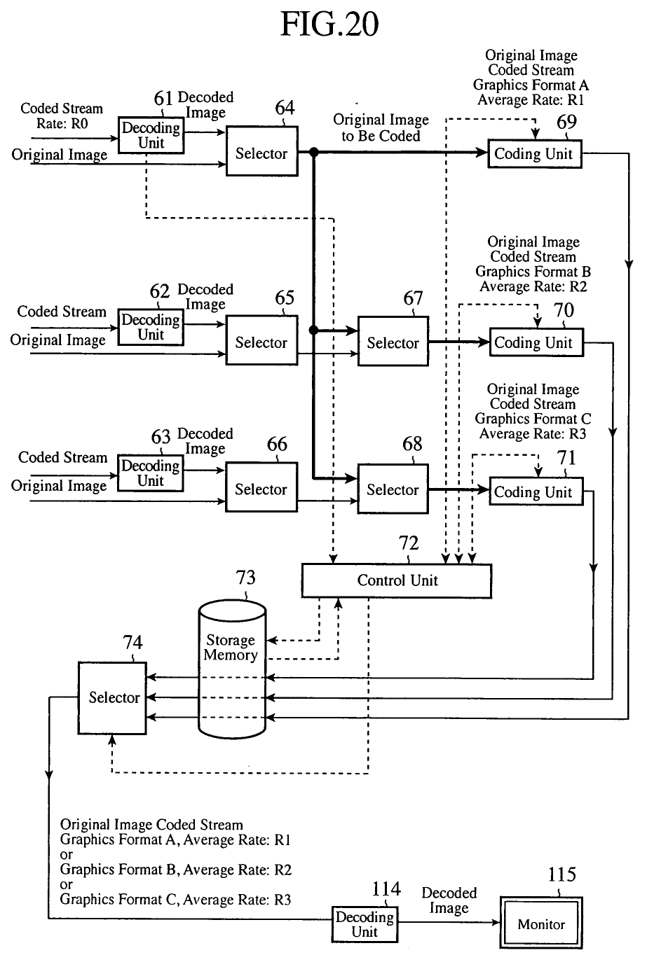

FIG. 20 is a block diagram showing the structure of an image coding, recording and reading apparatus in accordance with embodiment 5 of the present invention. In the figure, the same functional units as those shown in FIG. 12 of above-mentioned embodiment 3 are designated by the same reference numerals as shown in FIG. 12.

This image coding, recording and reading apparatus is provided with a decoding unit 114 in addition to the structure of FIG. 12. The decoding unit 114 is a means for decoding an original image coded stream which is selected by the selector 74 from two or more original image coded streams acquired by coding one original image to be coded stored in the storage memory 73 so as to acquire a decoded original image. This image coding, recording and reading apparatus differs from that of embodiment 3 in that it provides the decoded original image to a monitor 115 to display it. Therefore, the operation of each unit of the apparatus except the decoding unit 114 is the same as that of what is explained in embodiment 3. The features of this embodiment 5 acquired from the components located before the decoding unit 11 can also be applied to above-mentioned embodiment 3.

A coding method of coding an original image to be coded by using two or more coding units in accordance with this embodiment 5 will be explained.

When the user requests the apparatus to record only one certain program into the storage memory 73, the apparatus codes the original image to be coded of the program in a record time mode (an average coding rate) which the user presets by using the coding unit 69. When the user presets a 4-hour record mode (i.e., a mode in which a program of about 4 hours can be recorded into a single-sided 4.7-Gbyte DVD disk: which is also called LP mode in some DVD recorders catalogs). The coding unit 69 codes the original image to be coded of the program in this mode, and stores the generated original image coded stream in the storage memory 73. At this time, the selector 67 selects the output of the selector 64 and then provides it to the coding unit 70, and the selector 68 similarly provides the output of the selector 64 to the coding unit 71. The coding unit 70 codes the original image to be coded of the same program in a recording mode with higher quality than that of the above-mentioned recording mode which the user presets, e.g., in a 2-hour record mode (also called SP mode), or in another mode with a higher average coding rate than the 4-hour record mode, which are not written in DVD recorders catalogs, and stores the generated original image coded stream in the storage memory 73. In this case, the original image coded stream generated by the coding unit 70 is an original image coded stream having higher quality than that generated by the coding unit 69. Similarly, the coding unit 71 also codes the original image to be coded of the same program in a different recording mode from that in which the coding units 69 and 70 carry out the coding, and stores the generated high quality original image coded stream in the storage memory 73.

In this embodiment 5, the handling of the high-quality original image coded streams generated by the coding units 70 and 71 is implemented by means of the same method as that at the time of handling the difference image coded stream which is explained in above-mentioned embodiment 4.

The high-quality original image coded streams stored in the storage memory 73 will be properly erased according to the remaining amount of the recordable region of the storage memory 73. That is, each of the high-quality original image coded streams is treated strictly as an auxiliary stream which may not be there. If a corresponding high-quality original image coded stream exists in the storage memory 73 when the user makes the apparatus play back the above-mentioned program which it has recorded, the apparatus decodes the coded stream by using the decoding unit 114, and provides and displays the generated decoded original image to and on the monitor 115. In contrast, when no corresponding high-quality original image coded stream exists in the storage memory 73, the apparatus decodes the original image coded stream recorded in the recording mode specified by the user by using the decoding unit 114, and then provides and displays the decoded original image to and on the monitor 115.

The method of erasing a high-quality original image coded stream, the management method of managing an original image coded stream recorded in a recording mode specified by the user, display of information indicating enable/disable of a high-quality playback of an image on the screen for notifying program information recorded to the user, and so on are the same as those in the case of a difference image coded stream explained in above-mentioned embodiment 4. However, a high-quality original image coded stream in accordance with this embodiment 5 differs from a difference image coded stream in that the high-quality original image coded stream itself is obtained by coding an original image to be coded, and it can be simply displayed after being only decoded. Therefore, unlike in the case of a difference image coded stream in above-mentioned embodiment 4, because the apparatus does not perform the process of adding a high-quality original image coded stream to a decoded original image, the playback system requires only the single decoding unit 114. Furthermore, the apparatus does not need to have any mechanism of achieving synchronization between frames.

As explained in above-mentioned embodiment 4, at the time when carrying out the coding, the apparatus can provide a delay of several frames for each frame which is to be coded among the coding units 69, 70, and 71. For example, when coding a certain frame, the coding unit 70 codes the frame at the expiration of several frames after the coding unit 69 codes the frame, and, at the expiration of several frames the coding unit 71 codes the frame. In this case, the coding unit 70 uses the coded result from the coding unit 69, and the coding unit 71 uses the coded results from the coding units 69 and 70. To be more specific, at the expiration of several frames after the coding unit 69 carries out the coding in the recording mode which the user presets, the coding unit 70 carries out the coding in a higher-quality recording mode, thereby being able to optimize the assignment of an amount of information to each frame, the selection of a mode, etc., and further being able to make a higher-quality playback.

In actual fact, when the importance of the original image coded stream, the average coding rate, and the case in which the high quality coded stream is erased are taken into consideration in a relation between the original image coded stream in the recording mode which the user presets and the high-quality original image coded stream, there is a large advantage in improving the image quality of the original image coded stream in the recording mode which the user presets. To this end, the apparatus is so constructed as to carry out the coding in a high-quality recording mode first by using the coding unit 69, and, at the expiration of several frames, carry out the coding in the recording mode which the user presets by using the coding unit 70 while using coding information about frames acquired by the coding unit 69 which has carried out the coding. As a result, the assignment of the amount of information to each frame, the selection of a mode, etc. can be optimized, and extreme image quality degradation can be prevented even at a low rate.

The apparatus can be so constructed as to code an image of an identical program in an identical recording mode which the user presets by using the structure in accordance with this embodiment 5 and by using the plurality of coding units 69, 70, and 71. In this case, the plurality of coding units 69, 70, and 71 code the one original image to be coded in an identical graphics format and at an identical coding rate, and by using different coding parameters, such as different intervals of P pictures and different quantization matrices, and record generated original image coded streams into the storage memory 73, respectively. When each of the plurality of coding units includes a mechanism of computing the average of quantization scales and an S/N ratio when the coding of the image of the whole program is completed, the apparatus can compare the average of the quantization scales and the S/N ratio of the original image among the original image coded streams recorded into the storage memory 73, leave only the original image coded stream which is judged as having best image quality, and erase the other original image coded streams from the storage memory 73. By doing in this way, when coding an image of a program in an identical recording mode that the user presets using the plurality of coding units, the apparatus can put an original image coded stream of optimal image quality to use.

As mentioned above, the apparatus according to this embodiment 5 codes one image to be coded in a record time mode and a graphics format which the user presets so as to generate an original image coded stream, codes the same image to be coded in a mode with higher quality and higher resolution than those of the above-mentioned coding so as to generate an original image coded stream of higher quality than that of the above-mentioned coding, and records the original image coded streams into the storage memory. Therefore, by using an empty region of the storage memory, which is not used originally, for the storage of the high-quality original image coded stream, the apparatus can use the storage memory more effectively while it can make a playback with higher quality than the image quality in the recording mode which the user presets. Furthermore, because the apparatus properly erases a high-quality original image coded stream according to the remaining amount of the recordable region of the storage memory, the original image coded stream cannot be necessarily recorded by only a shorter time than originally expected because of the storage of high-quality original image coded streams, and the apparatus can use all of the first record time of the storage memory for the recording of the original image coded stream in the recording mode which the user presets. Because the original image coded stream in the recording mode which the user presets by himself or herself remains even if the corresponding high-quality original image coded stream is erased, the apparatus can make a playback with the image quality originally preset by the user and therefore the user does not suffer any drawbacks.

In a case in which a high-quality original image coded stream exists in the storage memory, when recoding the high-quality original image coded stream in order to record it into an external disk of small capacity, as shown in above-mentioned embodiment 1, the apparatus decodes the high-quality original image coded stream and then codes the decoded original image, thereby being able to reduce the degradation of the image quality at a low rate to a minimum.

### Embodiment 6

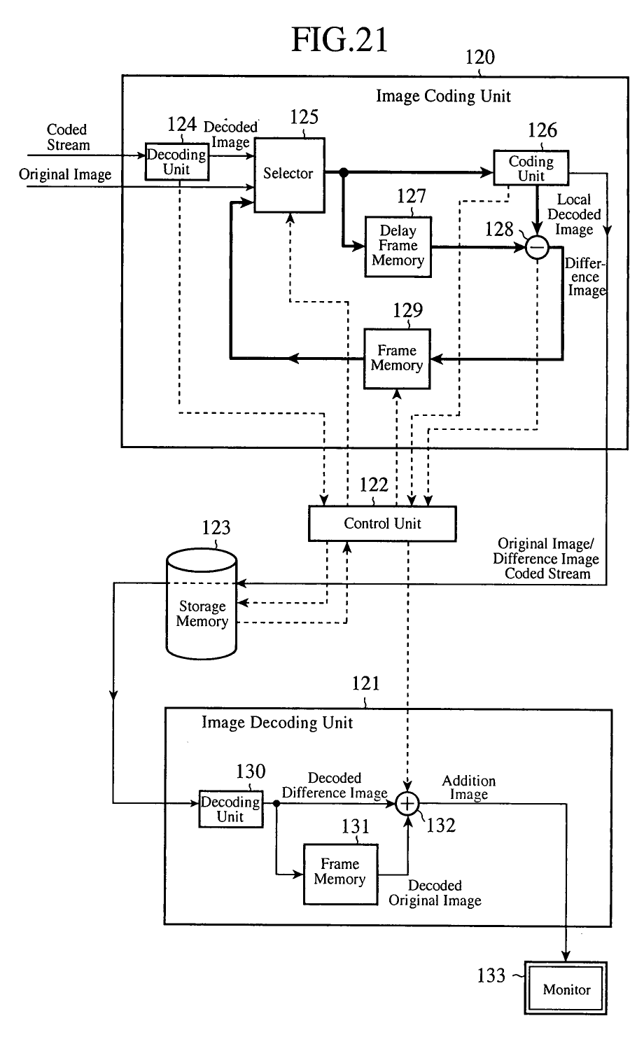

FIG. 21 is a block diagram showing the structure of an image coding, recording and reading apparatus in accordance with embodiment 6 of the present invention. This image coding, recording and reading apparatus is provided with an image coding unit 120, an image decoding unit 121, a control unit 122, and a storage memory 123.

In the structure of the image coding unit 120, a decoding unit 124 is a means for, when the input to the image coding, recording and reading apparatus is a coded stream, decoding it. A selector 125 is a means for selecting, as an original image to be coded, either a decoded image obtained by the decoding unit 124 or an original image inputted independently, and for selecting either this selected original image to be coded or a difference image from a frame memory (a first frame memory) 129. A coding unit 126 is a means for coding the original image to be coded which is inputted thereto. The coding unit 126 has a function of outputting a local decoded image which is used for motion compensation prediction in a display order, like the coding unit 10 of embodiment 1 shown in FIG. 1. A delay frame memory 127 is a means for providing the inputted image with an amount of delay for establishing synchronization with the frame positions of the local decoded image from the coding unit 126, which is furnished to a difference unit 128. The difference unit 128 is a means for calculating a difference between the delayed original image to be coded and the local decoded image from the coding unit 126 so as to generate a difference image. The frame memory 129 is a means for holding several frames of the difference image generated by the difference unit 128.

The control unit 122 is a means for acquiring, as supplementary information, information on results of the operation of each unit of the image coding, recording and reading apparatus from each unit, and for setting up a mode for each unit. The storage memory 123 in accordance with the present invention is a storage means for recording and reading the coded streams of the original image and the difference image, and the supplementary information which the control unit 122 has acquired from each unit.

In the structure of the image decoding unit 121, a decoding unit 130 can be so constructed as to be the same as the decoding unit 124 of the image coding unit 120. The decoding unit 130 is a means for reading the original image coded stream and the difference image coded stream from the storage memory 123, and for decoding them. A frame memory (i.e., a second frame memory) 131 is a means for holding several frames of the decoded original image decoded by the decoding unit 130. A decoding adder unit 132 is a means for adding the decoded difference image decoded by the decoding unit 130 to the decoded original image from the frame memory 131, and for furnishing and displaying the addition image to and on a monitor 133.

Next, the operation of the apparatus in accordance with this embodiment of the present invention will be explained.

The operation of generating the original image coded stream and the difference image coded stream, and recording them into the storage memory 123, and the operation of, when playing back the image, reading the original image coded stream and the difference image coded stream from the storage memory 123, decoding them, and adding the decoded original image and the decoded difference image to display the addition image are much the same as those explained in above-mentioned embodiment 4. While the apparatus in accordance with above-mentioned embodiment 4 performs the above-mentioned operations by using the plurality of coding units and the plurality of decoding units, the apparatus in accordance with this embodiment 6 differs from that in accordance with above-mentioned embodiment 4 in that it performs the above-mentioned operations by using a single coding unit and a single decoding unit.

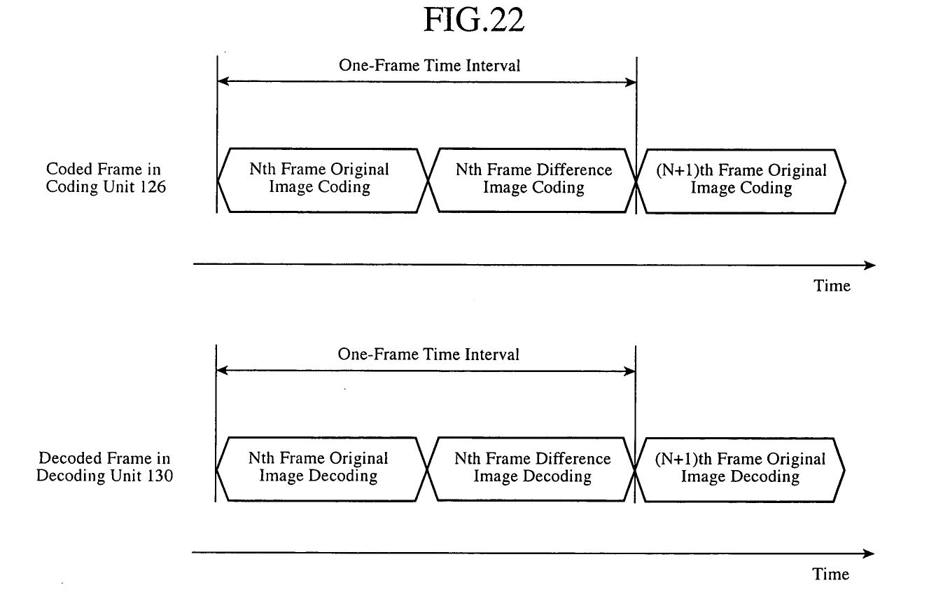

A coding unit which can code multiple frames during a one-frame time interval is used as the coding unit 126. A decoding unit which can decode multiple frames during a one-frame time interval is used as the decoding unit 130. A relation between coded frames and decoded frames which are processed during a one-frame time interval is shown in FIG. 22. For example, when coding the Nth frame as shown in FIG. 22, the coding unit 126 codes the original image to be coded during the first half of an one-frame time interval, and then codes the difference image during the second half of the one-frame time interval. The original image coded stream generated through the coding during the first half is recorded into the storage memory 123, and the local decoded image which the coding unit 126 generates at the same time when coding the original image to be coded is outputted in a display order. The difference unit 128 generates a difference image from this local decoded image outputted thereto and the original image to be coded on which the frame phase synchronization is performed by the delay frame memory 127. Several frames of this difference image are held by the frame memory 129.

Next, during the second half of the above-mentioned one-frame time interval, the difference image is read out of the frame memory 129, and is then furnished to the coding unit 126 via the selector 125. The coding unit 126 codes this difference image, and records the generated difference image coded stream into the storage memory 123. In these operations, control of the selector 125 for changing the image (switching between the original image to be coded and the difference image) which is to be inputted to the coding unit 126 in between during the first half of each one-frame time interval and during the second half of each one-frame time interval, control for outputting the difference image from the frame memory 129 in synchronization with the timing, and control for recording the original image coded stream and the difference image coded stream into the storage memory 123 separately are carried out by the control unit 122.

The decoding unit 130 decodes the original image coded stream read out of the storage memory 123 so as to generate a decoded original image during the first half of each one-frame time interval. The generated decoded original image is held by the frame memory 131 so that it is delayed and synchronized for addition with a decoded difference image which is to be generated during the second half of each one-frame time interval. The decoding unit 130 decodes the difference image coded stream read out of the storage memory 123 during the second half of each one-frame time interval so as to generate a decoded difference image. The generated decoded difference image is added to the decoded original image which was generated previously and delayed by the decoding adder unit 132, and the acquired addition image is provided and displayed to and on the monitor 133. In these operations, control for reading the original image coded stream and the difference image coded stream from the storage memory 123 during the first half and the second half of each one-frame time interval, respectively, and control for reading the decoded original image from the frame memory 131 in order to add the decoded original image and the decoded difference image which is created with the decoding are carried out by the control unit 122.

The same method as explained in above-mentioned embodiment 4 can also be applied to the difference image coded stream in accordance with this embodiment 6. That is, the difference image coded stream in accordance with this embodiment 6 can be made to have features which will be mentioned below.

The difference image coded stream recorded into the storage memory 123 can be erased according to the remaining amount of the storage memory 123.

The coding unit 126 can avoid generating the difference image coded stream according to the remaining amount of the storage memory 123.

The original image coded stream is stored in the storage memory 123, but, when the difference image coded stream corresponding to the original image coded stream is not stored in the storage memory, the decoding unit 130 can decode only the original image coded stream stored and the image decoding unit 121 can output only the decoded original image for playback instead of the addition image.

It is assumed that the original image coded stream and the difference image coded stream which are stored in the storage memory 123 are managed together for every program.

On the screen which is used for notifying information on a program recorded into the storage memory 123, a display indicating that a high-quality playback can be performed can be produced as to a program whose difference image coded stream is stored in the storage memory 123, while a display indicating that only a normal-quality playback can be performed can be produced as to a program whose difference image coded stream is not stored in the above-mentioned storage memory.

The remaining amount of the recordable region of the storage memory 123 which is notified to the user is an amount which is obtained by subtracting only the storage amount of the original image coded stream from the total capacity of the storage memory 123.

The order in which difference image coded streams are erased according to the remaining amount of the storage memory 123 is determined on the basis of either of the amount of each difference image coded stream, the date when each difference image coded stream was recorded, the record time mode of the original image which pairs each difference image, the averaged quantization scale value at the time of coding each corresponding original image to be coded and each corresponding difference image, the time which has elapsed since the last-time playback, the number of times that each difference image coded stream is played back, the genre of each corresponding program, and information indicating an improvement factor of the S/N ratio when using each corresponding difference image, or the user's selection.

Each difference image coded stream stored in the storage memory 123, when the corresponding original image coded stream is edited or erased, is edited or erased in cooperation with the edition or erase of the corresponding original image coded stream. At this time, when the editing of the difference image stream is impossible, it is erased.

The coding unit 126 can code the difference image in a coding mode different from that at the time of coding the original image to be coded. In this case, the mode in which the coding unit codes the difference image depends upon the coding type of the picture, the interval of P pictures, the quantization scale value, or the quantization matrix.

The coding unit 126 can code the difference image by changing a coding start position in the screen from which it starts the coding so that the coding start position differs from that at the time of coding the original image to be coded.

The coding unit 126 can code the difference image with the amount of information which is determined on the basis of the sum of the absolute pixel values of each frame of the difference image and which is assigned to each frame of the difference image.

The coding unit 126 can code the difference image with the amount of information which is determined on the basis of the average of the quantization scales of frames of the original image to be coded at the time of coding the original image to be coded, and which is assigned to each frame of the difference image.

The coding unit 126 can code the difference image with the amount of information which is determined on the basis of the genre information of the program, and which is assigned to each frame of the difference image.

The coding unit 126 can code the difference image after reducing the number of effective bits of the difference value. Instead of reducing the number of effective bits of the difference value, the coding unit can code the difference image by replacing any difference value which exceeds a range which can be expressed as a predetermined number of bits to be coded with a maximum or a minimum which can be expressed as a predetermined number of bits.

When coding the difference image, the coding unit 126 can total the number per frame of difference values which exceed the range which can be expressed as a predetermined number of bits to be coded, and perform a bit shift operation when the number of difference values is larger than a certain predetermined threshold, whereas, when the number of difference values is smaller than the above-mentioned predetermined threshold, the coding unit 126 can replace any difference value which exceeds the range which can be expressed as a predetermined number of bits to be coded with a maximum or a minimum which can be expressed as a predetermined number of bits without performing the bit shift operation.

The coding unit 126 can store supplementary information indicating a frame in which the bit shift operation is performed on each difference value, or a frame in which any difference value which exceeds the range which can be expressed as a predetermined number of bits to be coded is replaced by a maximum or a minimum which can be expressed as a predetermined number of bits in the storage memory 123, or can carry out multiplexing of the supplementary information to the user data of the difference image coded stream.

The coding unit 126 can code the difference image with the amount of information which is assigned to each frame on the basis of information on a region in each frame which catches a viewer's eyes, the information being produced when the original image to be coded is coded.

The coding unit 126 can code the difference image after removing signal components which are not effective visually, such as isolated points and noises, from the difference image by filtering this difference image.

When coding the difference image, the coding unit 126 carries out the coding by shifting the boundaries of the blocks to be coded of the original image to be coded horizontally by several pixels and perpendicularly by several lines.

When the average of the quantization scales of the frames of the difference image at the time of coding the difference image is larger than either a predetermined threshold or the average of the quantization scales of the frames of the original image to be coded at the time of coding the same frame of the original image to be coded, the decoding adder unit 132 does not have to add the decoded difference image to the decoded original image.

The decoding adder unit 132 adds the original image decoded image and the decoded difference image while establishing synchronization between their frames on the basis of time codes which match with each other and which are written into the GOP headers of the original image coded stream and the difference image coded stream, a synchronizing signal which is multiplexed into the user data, or a signal for synchronization which is described in VOBU defined by the DVD recorder standards.

As mentioned above, the apparatus according to this embodiment 6 includes the coding unit having a function of coding two or more frames during a one-frame time interval, for, when an original image to be coded is inputted thereto, coding the original image to be coded so as to generate an original image coded stream, and recording this stream into the storage memory, for outputting a local decoded image which is used for motion compensation prediction at the time of coding in a display order, and for, when a difference image is inputted thereto, coding the difference image so as to generate a difference image coded stream, and recording this stream into the above-mentioned storage memory, the delay frame memory for delaying the original image to be coded by a predetermined time interval when the above-mentioned original image to be coded is inputted thereto, the difference unit for acquiring the difference image from the original image to be coded from this delay frame memory, and the local decoded image outputted from the above-mentioned coding unit, the first frame memory for holding two or more frames of the difference image acquired, the selector for alternately selecting either the original image to be coded or the difference image currently held by the first frame memory during a one-frame time interval, and for inputting it to the coding unit and the delay frame memory, the decoding unit having a function of decoding two or more frames during a one-frame time interval, for decoding each of the original image coded stream and the difference image stream alternately read out of the storage memory, the second frame memory for holding two or more frames of the decoded original image obtained by the decoding unit, and the adder unit for adding the decoded difference image obtained by the decoding unit to the decoded original image currently held by the second frame memory so as to generate an addition image. Therefore, even when the number of coding units included in the apparatus is one and the number of decoding units included in the apparatus is one, the apparatus can carry out coding and decoding of an original image, can also carry out coding and decoding of a difference image, and can maintain the image quality, like that of embodiment 1 or 4.

In a case in which the functions of the coding unit and the decoding unit shown in this embodiment 6 are implemented via software which uses a microprocessor, whether to carry out a control operation of adaptively determining whether to carry out creation of the difference image coded stream or whether to carry out decoding of the difference image coded stream can also be taken into consideration according to the processing capability of the microprocessor and the load state at that time.

### Embodiment 7

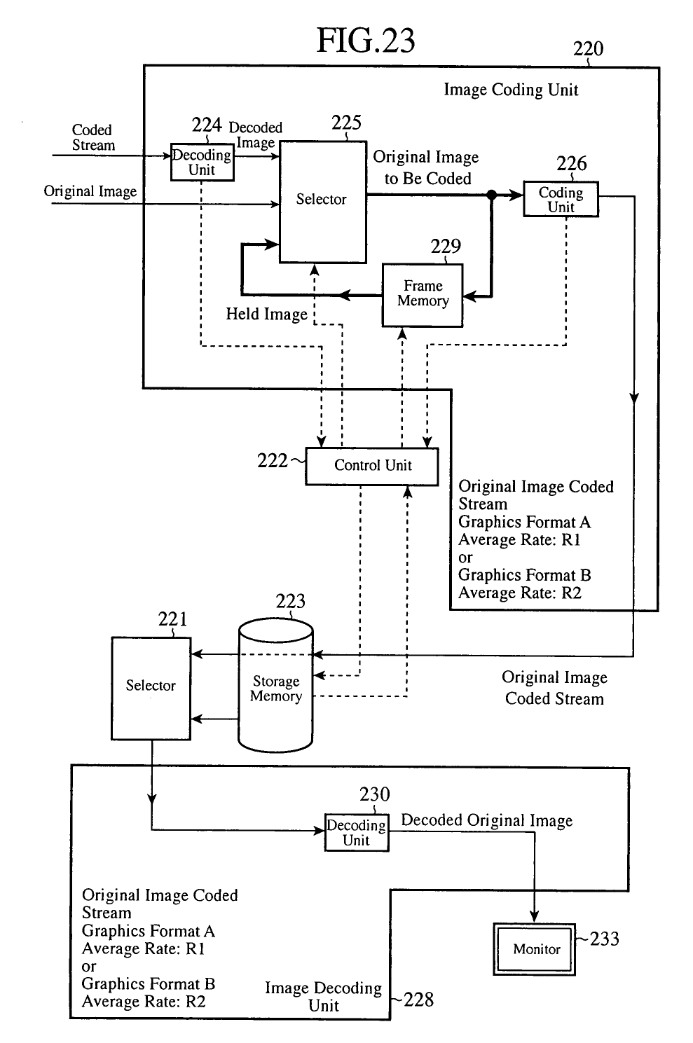

FIG. 23 is a block diagram showing the structure of an image coding, recording and reading apparatus in accordance with embodiment 7 of the present invention.

In FIG. 23, a decoding unit 224 is a means for, when the input to the image coding, recording and reading apparatus is a coded stream, decoding it. A selector 225 is a means for selecting, as an original image to be coded, either the decoded image generated by the decoding unit 224 or an original image inputted separately, and for selecting either this selected original image to be coded or an image being held from a frame memory 229. A coding unit 226 is a means having a function of coding multiple frames during a one-frame time interval, for coding the original image to be coded which is inputted thereto. The frame memory 229 is a means for holding multiple frames of the original image to be coded when the original image to be coded is inputted to the apparatus.

A control unit 222 is a means for acquiring, as supplementary information, information on results of the operation of each unit of the image coding, recording and reading apparatus from each unit, and for setting up a mode for each unit. A storage memory 223 in accordance with the present invention is a storage means for recording and reading two or more coded streams of the original image, and the supplementary information which the control unit 222 has acquired from each unit. A selector 221 is a means for selecting one coded stream to be read out from two or more original image coded streams recorded into the storage memory 223. A decoding unit 230 is a means for decoding the original image coded stream read out of the storage memory 223, and for furnishing and displaying a decoded original image generated thereby to and on a monitor 233.

Next, the operation of the apparatus in accordance with this embodiment of the present invention will be explained.

When generating two or more original image coded streams from an original image to be coded about one program, storing them in the storage memory 223, and playing back it, this image coding, recording and reading apparatus reads an original image coded stream depending upon (or suiting) its use from the storage memory 223 and decodes it in almost the same way as explained in above-mentioned embodiments 3 and 5. While the apparatus in accordance with either of embodiments 3 and 5 carries out the above-mentioned operation by using two or more coding units in order to generate two or more original image coded streams, the apparatus in accordance with this embodiment 7 has a feature of performing the above-mentioned operation by using a single coding unit.

A coding unit which can code multiple frames during a one-frame time interval is used as the coding unit 226. This operation of coding multiple frames during a one-frame time interval is performed in a way similar to that explained with reference to FIG. 22 of above-mentioned embodiment 6. In this embodiment 7, the coding unit codes the original image to be coded during the first half of each one-frame time interval, and then codes an image being held which corresponds to the above-mentioned original image to be coded which is read out of the frame memory 229 during the second half of each one-frame time interval.

The coding unit 226 codes the original image to be coded inputted during the first half of each one-frame time interval, and then records the generated original image coded stream into the storage memory 223. In this case, the coding is carried out in a record time mode (an average coding rate) and a graphics format which the user presets. At this time, the same original image to be coded is furnished to the frame memory 229, and several frames thereof are held by the frame memory. Next, during the second half of the above-mentioned one-frame time interval, the original image to be coded (referred to as the held image from here on) currently being held by the frame memory 229 is read out and is then furnished to the coding unit 226 via the selector 225. The coding unit 226 codes this held image, and records an original image coded stream generated thereby into the storage memory 223. In this case, the coding on the held image is carried out in a higher-quality higher-resolution mode than that in which the original image to be coded is coded during the first half of each one-frame time interval. Therefore, a high-quality original image coded stream is generated and recorded. In these coding operations, control of the selector 225 for changing the image (switching between the original image to be coded and the held image) which is to be inputted to the coding unit 226 in between during the first half of each one-frame time interval and during the second half of each one-frame time interval, control for outputting the held image from the frame memory 229 in synchronization with the timing, and control for recording the original image coded stream and the high-quality original image coded stream into the storage memory 223 separately are carried out by the control unit 222.

When either the original image coded stream or the high-quality original image coded stream is read out of the storage memory 223 by the selector 221 at the time of a playback, the apparatus decodes either the original image coded stream or the high quality original image coded stream so as to generate a corresponding decoded original image. The acquired decoded original image is furnished and displayed to and on the monitor 233.

The same method as explained in above-mentioned embodiment 5 can also be applied to the high-quality original image coded stream in accordance with this embodiment 7. That is, the difference image coded stream in accordance with this embodiment 6 can be made to have features which will be mentioned below.

The high-quality original image coded stream recorded into the storage memory 223 can be erased according to the remaining amount of the storage memory 223.

The high-quality original image coded stream recorded into the storage memory 223 does not have to be generated according to the remaining amount of the storage memory.

When the high-quality original image coded stream is not stored in the storage memory 223, the apparatus can select a corresponding original image coded stream stored and recorded in a record time mode (or an average coding rate) and a graphics format which the user presets instead of selecting the high-quality original image coded stream, and can output the selected original image coded stream for playback.

The original image coded stream recorded in a record time mode (an average coding rate) and a graphics format which the user presets, and the high-quality original image coded stream are managed together for every program.

On the screen which is used for notifying information on a program recorded into the storage memory 223, a display indicating that a high-quality playback can be performed can be produced as to a program whose difference image coded stream is stored in the storage memory 223, while a display indicating that only a normal-quality playback can be performed can be produced as to a program whose difference image coded stream is not stored in the storage memory 223.

The remaining amount of the recordable region of the storage memory 223 which is notified to the user is an amount which is obtained by subtracting only the storage amount of the original image coded stream recorded in a record time mode (an average coding rate) and a graphics format which the user presets from the total capacity of the storage memory 223.

The order in which high-quality original image coded streams are erased according to the remaining amount of the storage memory 223 is determined on the basis of either of the amount of each high-quality original image coded stream, the date when each high-quality original image coded stream was recorded, the record time mode and the graphics format which the user presets, the time which has elapsed since the last-time playback of each high-quality original image coded stream, the number of times that each high-quality original image coded stream is played back, the genre of each program, and information indicating an improvement factor of the S/N ratio when decoding and playing back each high-quality original image coded stream, or the user's selection.

Each high-quality original image coded stream stored in the storage memory 223, when the corresponding original image coded stream recoded in a record time mode (an average coding rate) and a graphics format which the user presets is edited or erased, is edited or erased in cooperation with the edition or erase of the corresponding original image coded stream. At this time, when the editing of the high-quality original image coded stream is impossible, it can be erased.

The other one of the pair of codings can be carried out with a delay of several frames being provided, and the coding information on each frame acquired from the coding which is carried out previously can be used in the other coding which will be carried out after several frames.

As mentioned above, the apparatus according to this embodiment 7 includes the frame memory for, when an original image to be coded is inputted thereto, holding two or more frames of the original image to be coded, the selector for alternately selecting either the original image to be coded or a held image from the frame memory, which corresponds to the original image to be coded, and for outputting it during the above-mentioned one-frame time interval, the coding unit having a function of coding two or more frames during a one-frame time interval, for, when the original image to be coded is inputted thereto from the selector, coding the original image to be coded in a record time mode and a graphics format which a user presets so as to generate an original image coded stream, and recording this stream into the storage memory, and for, when the corresponding held image from the selector is inputted thereto, codes it in a high-quality high-resolution mode so as to generate a high-quality original image coded stream, and recording this stream into the storage memory, and the decoding unit for decoding either the original image coded stream or the high-quality original image coded stream read out of the storage memory so as to generate a corresponding decoded original image. Therefore, even when the number of coding units included is one, the apparatus can generate two or more original image coded streams with different degrees of image quality through the coding on an original image, and provides the same advantages as offered by that of embodiment 5.

In the example explained in this embodiment 7, the coding unit for coding multiple frames during each one-frame time interval generates two original image coded streams with different degrees of image quality through coding every two frames, as previously shown. As an alternative, the coding unit can code three or more frames during each one-frame time interval. In this variant, the apparatus can acquire two or more high-quality original image coded streams.

### Embodiment 8

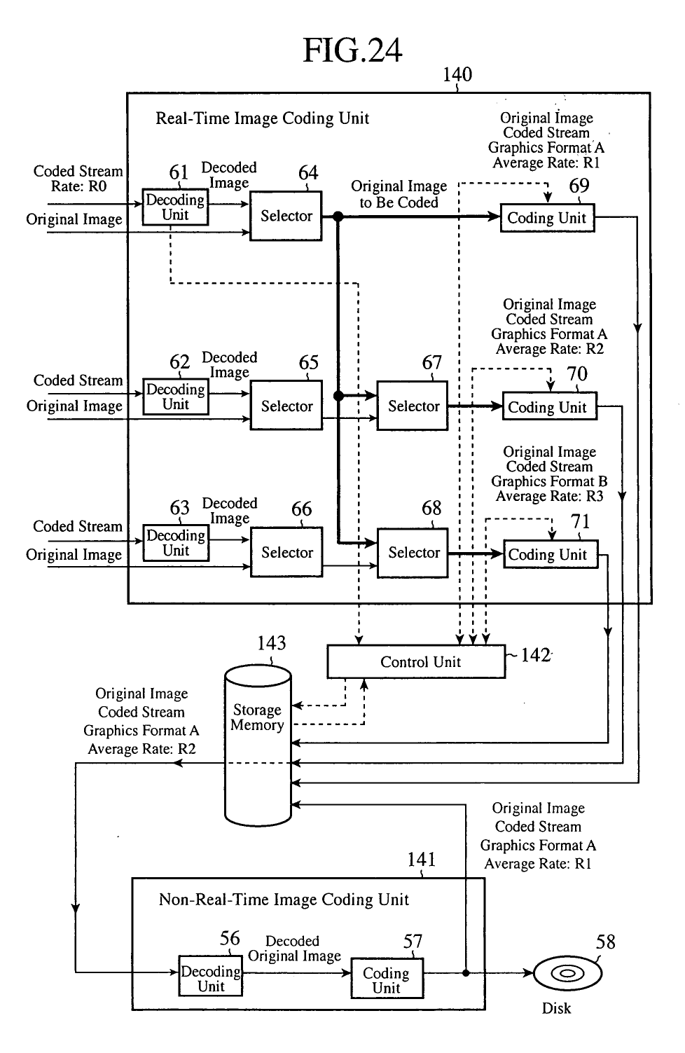

FIG. 24 is a block diagram showing the structure of an image coding, recording and reading apparatus in accordance with embodiment 8 of the present invention.

The image coding, recording and reading apparatus is provided with a real-time image coding unit 140, a non-real-time image coding unit 141, a control unit 142, and a storage memory 143. Functional units which construct the real-time image coding unit 140 and which are the same as those shown in FIG. 12 of embodiment 3 are designated by the same reference numerals as shown in the figure. Functional units which construct the non-real-time image coding unit 141 and which are the same as those shown in FIG. 10 of embodiment 2 are designated by the same reference numerals as shown in the figure.

The control unit 142 is a means for setting up a mode for each unit of the image coding, recording and reading apparatus, and for acquiring information associated with the processing operation of each unit. The storage memory 143 is a storage means for recording an original image coded stream and the information which the control unit 142 has acquired from each unit, and for reading them. An external disk 58 is a dismountable recording medium for recording a coded stream generated by a coding unit 57.

The apparatus in accordance with this embodiment 8 has a feature of not only recording the coded stream generated by the coding unit 57 into the external disk 58, but also recording it into the storage memory 143.

In accordance with this embodiment 8, the apparatus can be provided with the following functions.

When a user tries to record a certain program, while coding and recording an image of the program in a graphics format and a record time mode (an average coding rate) which the user presets, the apparatus also codes the image in a higher-definition graphics format than the graphics format which the user presets, or at a rate higher than an average coding rate which the user presets, and records the coded image. The image coding, recording and reading apparatus, in a state in which it does not perform any operation of recording or playing back a program according to a user's intention (i.e., a state in which it is assumed to be placed in a non-use state from its outward appearance), decodes a high-definition high-rate original image coded stream, and carries out recoding of an image decoded in non-real time by using coding information acquired and recorded at the time of real-time coding. At the time of this recoding, the apparatus carries out the coding in the same graphics format as and at the same average coding rate as those which the user presets at the time of real-time coding. The apparatus then records the generated original image coded stream into the storage memory 143 again.

When the above-mentioned recoding is completed, the apparatus compares coding information in the mode which the user presets at the time of real-time coding with coding information at the time of carrying out the recoding, and leaves only an original image coded stream which it has judged as having better image quality in the storage memory 143 while erasing another original image coded stream which it has judged as having worse image quality and the original image coded stream which it has acquired by coding the original image in the mode with higher definition and higher rate than those preset by the user from the storage memory 143.

Next, a concrete operation of the apparatus will be explained.

Assume that at the time of real-time coding, a user sets the apparatus to a mode in which it codes an image of a program in a graphics format A and at an average coding rate R1. At this time, the coding unit 69 codes the image in the graphics format A and at the average coding rate R1 so as to generate an original image coded stream, and records it into the storage memory 143. Simultaneously, the coding unit 70 codes the image in the graphics format A and at an average coding rate R2 (>R1) so as to generate an original image coded stream, and records it into the storage memory 143.

Next, in a state in which the image coding, recording and reading apparatus does not perform any operation of recording or playing back a program according to a user's intention, the non-real-time image coding unit 141 reads the original image coded stream which has been coded at the average coding rate R2 from the storage memory 143, and decodes it by using the decoding unit 56. The non-real-time image coding unit then codes the decoded original image generated through the decoding at the average coding rate R1 by using the coding unit 57. The coding unit 57 reads information on all frames which were recorded when it coded the original image in real time from the storage memory 143, carries out assignment of an optimal amount of information to each frame, codes the decoded original image, and records the generated original image coded stream into the storage memory 143 again. As a result, from the original image coded stream currently recorded into the storage memory 143, the original image coded stream of average coding rate R1 and that of average coding rate R2 which were acquired by coding the original at the time of real-time coding, and the original image coded stream of average coding rate R1 currently acquired by coding the decoded original image at the time of this non-real-time coding are provided.

Next, only an original image coded stream which is judged as having better image quality is selectively left from among the original image coded stream of average coding rate R1 which is acquired at the time of real-time coding and the original image coded stream of average coding rate R1 which is acquired at the time of non-real-time coding, which are recorded into the storage memory 143, while the other original image coded stream of average coding rate R1 which is judged as having worse image quality and the original image coded stream of average coding rate R2 are erased. In this case, as coding information which is used for the judgment of image quality, the average of the quantization scale values per frame at the time of coding can be used.

When the graphics format at the time of real-time coding differs (for example, a graphics format B), the coding unit 57 carries out the coding after changing the graphics format to the graphics format which the user presets (in this example, the graphics format A).

As mentioned above, the apparatus according to this embodiment 8 codes one original image to be coded in a graphics format and at an average coding rate which a user sets up, also codes the original image to be coded either in a finer graphics format than the graphics format which the user sets up or at a rate higher than the average coding rate which the user sets up, records each acquired original image coded stream into the storage memory, decodes the original image coded stream coded at the higher average coding rate which is read out of the storage memory when the apparatus is placed in a state in which it does not perform a recoding and playback operation according to the user's intention, recodes the decoded original image generated through the decoding at the average coding rate which the user sets up by carrying out assignment of an optimal amount of information to each frame on the basis of information about frames at the time when the apparatus carries out the coding for the first time, records the original image coded stream generated through the recoding into the storage memory, selectively leaves only a coded stream which is judged as having better image quality from among the original image coded streams about the one original image to be coded which are currently recorded into the storage memory, erases all other original image coded streams which are judged as having bad image quality, and reads the coded stream which is recorded into the storage memory and which is judged as having better image quality at the time of a playback of the coded stream. Therefore, the apparatus can provide the user with a good image-quality coded stream at the time of playback.

### INDUSTRIAL APPLICABILITY

As mentioned above, the image coding, recording and reading apparatus in accordance with the present invention is applied to a DVD recorder equipped with two or more coding units in order to make the DVD recorder have a function of simultaneously recording two or more programs and is suitable for achieving a high quality playback output by combining the two or more coding units because the image coding, recording and reading apparatus, when coding and recording an image, and then playing back it, can provide an image having quality equivalent to that of the original image when recorded or higher quality.

1. An image coding, recording and reading apparatus which codes an original image to be coded according to a predetermined coding method, records the coded original image into a storage memory, and outputs a coded stream read out of said storage memory in a form depending upon (or suiting) a use of the coded stream, characterized in that said apparatus comprises:
an image coding means for generating a local decoded image which is used for motion compensation prediction from the original image to be coded at a same time when coding the original image to be coded so as to generate an original image coded stream, for acquiring a difference image which is a difference between said local decoded image and said original image to be coded, for coding the acquired difference image so as to generate a difference image coded stream, and for recording the original image coded stream and the difference image stream generated thereby into said storage memory; and
an image decoding means for decoding each of said original image coded stream and said difference image coded stream read out of said storage memory to generate a decoded original image and a decoded difference image, and for adding both the decoded images so as to generate an addition image.

2. The image coding, recording and reading apparatus according to claim 1, characterized in that
the image coding means includes:
a first coding unit for coding the original image to be coded to generate the original image coded stream and recording it into the storage memory, and for outputting the local decoded image which is used for motion compensation prediction at a time of coding in a display order;
a delay frame memory for delaying said original image to be coded by a predetermined time interval;
a difference unit for acquiring the difference image from the original image to be coded from said delay frame memory and the local decoded image outputted from said first coding unit; and
a second coding unit for coding said difference image to generate the difference image coded stream, and for recording this stream into said storage memory,
and the image decoding means includes:
a first decoding unit for reading the original image coded stream from said storage memory and decoding this stream;
a second decoding unit for reading the difference image coded stream from said storage memory and decoding this steam; and
an adder unit for adding the decoded original image generated by said first decoding unit and the decoded difference image generated by said second decoding unit so as to generate the addition image.

3. The image coding, recording and reading apparatus according to claim 2, characterized in that a real-time VBR image coding means for carrying out coding through its real-time VBR operation is formed of the structural components of the image coding means, and a non-real-time VBR image coding means is formed of the structure components of the image decoding means, and a third coding unit for coding the addition image generated by the adder unit so as to generate an addition image coded stream.

4. The image coding, recording and reading apparatus according to claim 3, characterized in that when coding the addition image at a coding rate which is equal to or lower than an average coding rate at which the first coding unit codes the original image to be coded, the third coding unit codes the addition image on a basis of a target amount of information which is determined from supplementary information acquired at a time of the coding by the real-time VBR image coding means and which is assigned to all frames in a time direction.

5. The image coding, recording and reading apparatus according to claim 3, characterized in that the first coding unit and the third coding unit share a single coding unit.

6. The image coding, recording and reading apparatus according to claim 1, characterized in that the difference image coded stream recorded into the storage memory is erased according to a remaining amount of said storage memory.

7. The image coding, recording and reading apparatus according to claim 1, characterized in that the coding of the difference image is so performed as to prevent the difference image coded stream from being generated according to a remaining amount of the storage memory.

8. The image coding, recording and reading apparatus according to claim 1, characterized in that when the original image coded stream is stored in the storage memory, but any difference image coded stream corresponding to the original image coded stream is not stored in the storage memory, the image decoding means decodes only the original image coded stream stored so as to generate the decoded original image, and outputs only the decoded original image instead of the addition image.

9. The image coding, recording and reading apparatus according to claim 1, characterized in that as to a program whose difference image coded stream is stored in the storage memory, said apparatus displays information indicating that a high-quality playback can be performed on a screen for notifying information about a program which is recorded in the storage memory, whereas as to a program whose difference image coded stream is not stored in said storage memory, said apparatus displays information indicating that only a normal-quality playback can be performed on the screen.

10. The image coding, recording and reading apparatus according to claim 1, characterized in that a recordable remaining amount of the storage memory which is notified to a user is an amount which is obtained by subtracting only a storage amount of the original image coded stream from a total capacity of the storage memory.

11. The image coding, recording and reading apparatus according to claim 1, characterized in that the coding of the difference image is carried out on a basis of an amount of information which is assigned to each frame of the difference image, the amount of information being determined on a basis of a sum of absolute values of each frame of the difference image.

12. The image coding, recording and reading apparatus according to claim 1, characterized in that the coding of the difference image is carried out on a basis of an amount of information which is assigned to each frame of the difference image, the amount of information being determined on a basis of an average of quantization scales of each frame at a time when the original image to be coded is coded.

13. The image coding, recording and reading apparatus according to claim 1, characterized in that the coding of the difference image is carried out on a basis of an amount of information which is assigned to each frame of the difference image, the amount of information being determined on a basis of genre information about a program.

14. The image coding, recording and reading apparatus according to claim 1, characterized in that instead of reducing a number of effective bits of difference values, the coding of the difference image is carried out by replacing each difference value which exceeds a range which can be expressed as a predetermined number of bits to be coded with a maximum or a minimum which can be expressed as a predetermined number of bits.

15. The image coding, recording and reading apparatus according to claim 1, characterized in that when coding the difference image, said apparatus totals a number of difference values each of which exceeds a range which can be expressed as a predetermined number of bits to be coded, carries out a bit shift operation when the number of difference values is larger than a certain predetermined threshold, and, when the number of difference values is smaller than said predetermined threshold, replaces it with a maximum or a minimum which can be expressed as a predetermined number of bits without carrying out the bit shift operation.

16. The image coding, recording and reading apparatus according to claim 3, characterized in that for the storage memory, two or more non-real-time VBR image coding means are disposed in parallel with each other, and carry out the decoding of the coded streams of the original image and the difference image, which are stored in the storage memory, the addition of the decoded images decoded, and the coding of the addition image with time division or for separated portions of a screen, respectively.

17. An image coding, recording and reading apparatus which codes an original image to be coded according to a predetermined coding method, records the coded original image into a storage memory, and outputs a coded stream read out of said storage memory in a form depending upon (or suiting) a use of the coded stream, characterized in that said apparatus comprises:
a real-time VBR image coding means for coding one original image to be coded in different coding modes by using two or more coding units, for recording only an original image coded stream generated by one of said two or more coding units into said storage memory, and for recording coding information including the different coding modes which are used simultaneously, and a total amount of information and an amount of motion vector information generated per frame which are acquired through each of coding operations of said two or more coding units into said storage memory; and
a non-real-time VBR image coding means for decoding the original image coded stream recorded in said storage memory by using a decoding unit, for recoding a generated decoded original image in a coding mode selected from said coding information by using a coding unit which is of a same type of said one of the two or more coding units, and by assigning a target amount of information which is predetermined on a basis of said coding information to all frames in a time direction, and for outputting a generated original image coded stream.

18. The image coding, recording and reading apparatus according to claim 17, characterized in that the real-time VBR image coding means, in a coding mode in which the two or more coding units do not record any generated original image coded streams into the storage memory, codes all frames with an identical fixed quantization scale.

19. The image coding, recording and reading apparatus according to claim 17, characterized in that the real-time VBR image coding means, in a coding mode in which the two or more coding units do not record any generated original image coded streams into the storage memory, codes intervals of P pictures with different fixed values, respectively.

20. The image coding, recording and reading apparatus according to claim 19, characterized in that before the non-real-time VBR image coding means operates, said apparatus compares amounts of information generated per a predetermined number of frames by the two or more coding units of the real-time VBR image coding means which do not record any generated original image coded streams into the storage memory with one another, selects an interval of P pictures having a smaller amount of generated information per said predetermined number of frames, and acquires a total amount of generated information in a coding mode at a time when said interval of P pictures is selected from said storage memory so as to determine a target amount of information which is assigned to each frame of a whole image on a basis of this total amount of generated information, and the coding unit of said non-real-time VBR image coding means switches to the interval of P pictures having a smaller amount of generated information per said predetermined number of frames in a corresponding coding mode, and recodes frames to which said amount of target information are assigned.

21. An image coding, recording and reading apparatus which codes an original image to be coded according to a predetermined coding method, records the coded original image into a storage memory, and outputs a coded stream read out of said storage memory in a form depending upon (or suiting) a use of the coded stream, characterized in that
said apparatus performs at least a pair of codings on one original image to be coded in different graphics formats and at different coding rates so as to generate original image coded streams, and records the generated original image coded streams into said storage memory, and selects an original image coded stream having a graphics format and a coding rate which depend upon (or suit) its use from the two or more original image coded streams recorded into said storage memory.

22. The image coding, recording and reading apparatus according to claim 21, characterized in that said apparatus carries out one of the pair of codings in a record time mode and a graphics format which a user presets and generates an original image coded stream, and said apparatus carries out the other one of said pair of codings in a mode having a higher quality and a higher resolution than said one of the pair of codings, and generates an original image coded stream having a higher quality than said original image coded stream.

23. The image coding, recording and reading apparatus according to claim 22, characterized in that the original image coded stream having a higher quality which is recorded into the storage memory is erased according to a remaining amount of the storage memory.

24. The image coding, recording and reading apparatus according to claim 22, characterized in that the original image coded stream having a higher quality which is recorded into the storage memory is not generated according to a remaining amount of the storage memory.

25. The image coding, recording and reading apparatus according to claim 22, characterized in that when the original image coded stream having a higher quality is not stored in the storage memory, said apparatus selects the stored original image coded stream having the record time mode and the graphics format preset by the user, instead of said original image coded stream having a higher quality, and plays back and outputs the selected original image coded stream.

26. The image coding, recording and reading apparatus according to claim 22, characterized in that as to a program whose high-quality original image coded stream is stored in the storage memory, said apparatus displays information indicating that a high-quality playback can be performed on a screen for notifying information about a program which is recorded in the storage memory, whereas as to a program high-quality original image coded stream is not stored in said storage memory, said apparatus displays information indicating that only a normal-quality playback can be performed on the screen.

27. The image coding, recording and reading apparatus according to claim 22, characterized in that a recordable remaining amount of the storage memory which is notified to a user is an amount which is obtained by subtracting only a storage amount of the original image coded stream having the record time mode and the graphics format preset by the user from a total capacity of the storage memory.

28. The image coding, recording and reading apparatus according to claim 21, characterized in that said apparatus carries out the other one of said pair of codings by providing a delay of several frames, and uses coding information about a frame which is acquired from the one of said pair of codings which said apparatus has previously carried out after completing coding of several frames.

29. An image coding, recording and reading apparatus which codes an original image to be coded according to a predetermined coding method, records the coded original image into a storage memory, and outputs a coded stream read out of said storage memory in a form depending upon (or suiting) a use of the coded stream, characterized in that
said apparatus performs two or more codings on one original image to be coded in an identical graphics format, at an identical coding rate, and with different coding parameters including different P picture intervals and different quantization matrices, records original image coded streams acquired thereby into said storage memory,
compares average quantization scales of the two or more original image coded streams recorded into said storage memory with one another, or compares S/N ratios of the two or more original image coded streams with an S/N ratio of the original image, erases all original image coded streams other than an original image coded stream which is judged as having best image quality from said storage memory, and
reads and decodes the original image coded stream which is recorded into said storage memory and which is judged as having best image quality so as to generate a decoded original image.

30. The image coding, recording and reading apparatus according to claim 1, characterized in that the image coding means includes:
a coding unit having a function of coding two or more frames during a one-frame time interval, for, when the original image to be coded is inputted thereto, coding the original image to be coded so as to generate the original image coded stream, and recording this stream into the storage memory, for outputting the local decoded image which is used for motion compensation prediction at the time of coding in a display order, and for, when the difference image is inputted thereto, coding the difference image so as to generate the difference image coded stream, and recording this stream into said storage memory;
a delay frame memory for delaying the original image to be coded by a predetermined time interval when the original image to be coded is inputted thereto;
a difference unit for acquiring the difference image from the original image to be coded from said delay frame memory, and the local decoded image outputted from said coding unit; a first frame memory for holding two or more frames of the difference image acquired by said difference unit; and
a selector for alternately selecting either the original image to be coded or the difference image currently held by said first frame memory during said one-frame time interval, and for inputting it to said coding unit and said delay frame memory;
and the image decoding means includes:
a decoding unit having a function of decoding two or more frames during a one-frame time interval, for decoding each of the original image coded stream and the difference image stream alternately read out of said storage memory;
a second frame memory for holding two or more frames of the decoded original image obtained by said decoding unit; and
an adder unit for adding the decoded difference image obtained by said decoding unit to the decoded original image currently held by said second frame memory so as to generate the addition image.

31. The image coding, recording and reading apparatus according to claim 22, characterized in that said apparatus includes:
a frame memory far, when the original image to be coded is inputted thereto, holding two or more frames of the original image to be coded;
a selector for alternately selecting either the original image to be coded or a held image from said frame memory, which corresponds to the original image to be coded, and for outputting it during said one-frame time interval;
a coding unit having a function of coding two or more frames during a one-frame time interval, for, when the original image to be coded is inputted thereto from said selector, coding the original image to be coded in a record time mode and a graphics format which a user presets so as to generate the original image coded stream, and recording this stream into the storage memory, and for, when the corresponding held image from said selector is inputted thereto, codes it in a high-quality high-resolution mode so as to generate a high-quality original image coded stream, and recording this stream into said storage memory; and
a decoding unit for decoding either the original image coded stream or the high-quality original image coded stream read out of said storage memory so as to generate a corresponding decoded original image.

32. An image coding, recording and reading apparatus which codes an original image to be coded according to a predetermined coding method, records the coded original image into a storage memory, and outputs a coded stream read out of said storage memory in a form depending upon (or suiting) a use of the coded stream, characterized in that said apparatus
codes one original image to be coded in a graphics format and at an average coding rate which a user presets,
also codes the original image to be coded either in a finer graphics format than the graphics format which the user presets or at a rate higher than the average coding rate which the user presets,
records each original image coded stream acquired thereby into said storage memory,
decodes the original image coded stream coded at the higher average coding rate which is read out of said storage memory when said apparatus is placed in a state in which it does not perform a recoding and playback operation according to the user's intention,
recodes the decoded original image generated through the decoding at said average coding rate which the user presets by carrying out assignment of an optimal amount of information to each frame on a basis of information about frames at a time when the coding is carried out for a first time,
records the original image coded stream generated through the recoding into said storage memory,
leaves only a coded stream which is judged as having better image quality among the original image coded streams about said one original image to be coded which are currently recorded into said storage memory,
erases all other original image coded streams which are judged as having bad image quality, and
reads the coded stream which is recorded into said storage memory and which is judged as having better image quality at a time of a playback of the coded stream.
